(19) United States
(12) Patent Application Publication
(10) Pub. No.: US 2003/0088368 A1
(43) Pub. Date: May 8, 2003

(54) Environmental management support system, environmental management support method, and storage medium storing program therefor

(76) Inventors: Osamu Inami, Fuchu-shi (JP); Shin Matsumoto, Koshigaya-shi (JP); Mitsunori Kaneda, Inagi-shi (JP); Hirokazu Hirayama, Kodaira-shi (JP); Hiroshi Hoshino, Arakawa-ku (JP); Yoshiyuki Tsuchida, Itabashi-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/306,081

(22) Filed: Nov. 29, 2002

Related U.S. Application Data
(63) Continuation of application No. PCT/JP01/04481, filed on May 29, 2001.

(30) Foreign Application Priority Data
May 29, 2000 (JP) 2000-159273

(51) Int. Cl. G06F 19/00; G01N 31/00

(52) U.S. Cl. 702/22

(57) ABSTRACT

An environmental management support system which calculates the release or transfer amount of a chemical substance contained in a target article includes a basic information registration means for registering predetermined basic information, a data input means having a use amount input section which inputs use amount data of the target article in each process, and calculates the release or transfer amount of the chemical substance contained in the target article in a predetermined period in each of the processes by using the input data and each information stored by the basic information registration means, and a means for outputting the release or transfer amount of the chemical substance calculated by the data input means in each of the processes.

### CROSS-REFERENCE TO RELATED APPLICATIONS

This is a Continuation Application of PCT Application No. PCT/JP01/04481, filed May 29, 2001, which was not published under PCT Article 21(2) in English.

This application is based upon and claims the benefit of priority from the prior Japanese Patent Application No. 2000-159273, filed May 29, 2000, the entire contents of which are incorporated herein by reference.

### BACKGROUND OF THE INVENTION

1. Field of the Invention

The present invention relates to a system for supporting environmental management of regulated substances, drainage, and the like in accordance with laws and regulations/statues.

2. Description of the Related Art

As global environmental problems are brought to the fore, there is worldwide movement toward appropriate management of various kinds of chemical substances by various methods in accordance with environments. This movement toward appropriate management includes the increasing approval of IS014001 and Agenda 21 adopted at the 1992 Earth Summit.

As one of the techniques for this purpose, the Pollutant Release and Transfer Register (to be referred to as “PRTR” hereinafter) system was started in 1999. Under this PRTR system, it is required to reduce not only the amounts of toxic chemical substances used but also transfer amounts such as release and disposal amounts aimed at environmental conservation. Environmental management becomes therefore important. The PRTR system requires companies and the like handling chemical substances to daily and accurately monitor the amounts of chemical substances released to the environment in production and manufacture processes and the like and the amounts of chemical substances transferred by being contained in wastes transported out of the establishment so as to improve the management of such chemical substances. This system also requires the companies to report (notify) the information about the monitored release/transfer amounts and the like of chemical substances to a government office.

The PRTR system defines a variety of potential toxic substances as well and achieves environmental protection by taking measures against such PRTR target substances on both the company side and the administration side. That is, this PRTR system requires companies and the like handling chemical substances to daily and accurately monitor the amounts of chemical substances released to the environment in production/manufacture process, consumption process, and the like and the amounts of chemical substances transferred by being contained in wastes transported out of the establishment so as to improve the management, e.g., storage and reduction, of such chemical substances. This system also requires the companies to report the information of the monitored release/transfer amounts and the like of chemical substances to the government office. In addition, the PRTR system requires the administration side to compile and disclose the information of the release/transfer amounts and the like of chemical substances reported from the companies and the like so as to allow the administration side itself or any person interested in the information to use it.

In order to reduce the amounts of toxic substances used in each of the production/manufacture process, consumption process, and the like and the amount of toxic substances transferred/released to the environment, it is important to take environmental management measures throughout the production/manufacture process. Several conventional proposals for this purpose have been made.

For example, in “Law Search Method and Law Search System” disclosed in Jpn. Pat. Appln. KOKAI Publication No. 11-306191, there are proposed a scheme of simply searching for a statute applied to a product, and a system for searching for an applied statute by inputting a product name.

In “Product Assessment Evaluation Apparatus” disclosed in Jpn. Pat. Appln. KOKAI Publication No. 9-319790, there is proposed an apparatus which performs assessment evaluation by comparing the design information of a produce with reference design information using an input format standardized to reduce the environmental load of the product.

The release amounts/transfer amounts of chemical substances to the environment are grasped in the following manner. An operation manager collects the data of use amounts of the respective chemical substances and writes them on a check sheet. At each report day, the operation manager obtains release amounts/transfer amounts by multiplying the use amount data by predetermined release rate and transfer rate obtained by empirically or actual measurement and creates a report.

Recently, the manager inputs data in a personal computer (to be abbreviated as “PC” hereinafter) instead of writing data on a check sheet, and creates a report based on the data.

Although PCs are used, collection of data and creation of reports are performed by methods unique to companies or operation managers. These methods are therefore not always efficient. In addition, some collected data may not be effective for management and improvements although a report may be created by using such data.

As described above, conventional data measurement techniques associated with chemical substances are still under development, and hence data management only by using PCs cannot be satisfactorily functional. That is, this technique has not been developed enough to improve the efficiency of use amount management and inventory management for chemical substances and the like.

More specifically, in order to create a report, it is required to input information associated with an establishment, e.g., the establishment name, location, and contact, information associated with laws, e.g., the names of chemical substances (regulated substances) that must be reported according to laws, data such as use amounts that are used to obtain the release amounts/transfer amounts of the regulated substances, and the like. In general, these pieces of information and data are input at a plurality of departments (persons in charge). For example, information associated with an establishment and information associated with laws are input by a person in charge at a general affair department, and data such as use amounts are input by a person in charge at a manufacture department.

If, therefore, the above information and data are allowed to be handled together, for example, the person in charge at the manufacture department may erroneously input information that should be input at the general affair department, thereby increasing the possibility of input errors. In addition, information and data are handled in different manners. For example, data such as use amounts need to be frequently input, whereas data such as an establishment hardly need to be updated once it is input.

Even if the release amounts/transfer amounts of chemical substances (regulated substances) are obtained, it is not always clear which measures should be taken to reduce the transfer amounts of regulated substances to the air. This is because the transfer rate of a regulated substance to the air may vary depending on a combination of target articles, the processing sequence (the order of processes), or the like. If transfer amounts are uniformly obtained from the use amounts at the respective departments (i.e., only in the respective processes), the resultant data are not satisfactory as data required to improve the environment.

When, therefore, chemical substances are managed by the conventional method, data collection and output task must be performed on a product basis by performing data collection, input processing, and output task such as printing twice or more.

Furthermore, since data collection and output task are manually performed, data and results need to be copied, resulting in human errors such as enter errors and decision errors, uselessness, and the like. In addition, only an operation manager who is an expert in bringing statutes/laws and regulations into correspondence with chemical substances and collecting data can perform correct decision and management with respect to chemical substances.

In conventional chemical substance management, there are many ambiguities in the correspondence between statutes/laws and regulations and management of chemical substances. More specifically, in the execution of compliance with statutes for the sake of environmental management complying with statutes, since a complicated decision needs to be made to comply with statutes/laws and regulations by bringing chemical substances into correspondence with the statutes/laws and regulations, the chemical substances cannot be made to uniquely correspond to the statutes/laws and regulations. It is therefore difficult to objectively/collectively manage the release/transfer amounts of chemical substances and make a legal decision.

In addition, the existing circumstances in which there are many types of target articles, and many changes are made to the constituent chemical substances of such target articles and designation by statutes/laws and regulations make also it difficult to bring statutes/laws and regulations into correspondence with management of chemical substances. Currently, various target articles containing various chemical substances exist in accordance with various industrial requests. With increasing diversification of industrial requests, the number of types of target articles is further increasing. In addition, with the revision of laws and the progress of technology, frequent changes are made to the constituent chemical substances of target articles. Furthermore, the chemical substances designated by PRTR-related laws vary country by country, and will be reconsidered with high possibility.

Under the circumstances, in the above technique of bringing product names into correspondence with applied statutes, file changes must be frequently made to bring them into correspondence with each other, resulting in complicated management. In spite of the fact that the target articles handled in one establishment are relatively limited, the conventional technique requires a large-scale server because an enormous file including chemical substances and statutes irrelevant to the establishment must be possessed.

Conventional support tools conforming to PRTR are limited to report work or demand input setting based on sophisticated chemical knowledge or knowledge about environment-related laws. This makes it difficult to use such tools at manufacturing sites.

### BRIEF SUMMARY OF THE INVENTION

It is an object of the present invention to provide data effective for management/improvements by calculating the release amounts/transfer amounts of chemical substances on a process basis.

It is another object of the present invention to reduce input errors and realize efficient data input operation by dividing the function of a system in accordance with work contents or the property of data to be input.

It is still another object of the present invention to efficiently provide programs or services from an environmental management support system of the present invention to a plurality of users.

In order to achieve the above objects, an environmental management support system of the present invention is configured to calculate the release amounts/transfer amounts of chemical substances in each process and allow independent execution of basic information registration, data input operation, and summation result output operation, thereby accurately managing the use amounts of chemical substances and efficiently supporting environmental management.

The following are the definitions of important terms used in this specification.

The term “basic information” is used to define information that need not be frequently updated, e.g., establishment information and discriminate information that is periodically input, e.g., use amount data.

The term “registration” is used to define the operation of storing information in an external storage device such as a semiconductor memory, magnetic disk, bulk memory, or CD-R, or an internal storage device.

The terms “use amount data” and “storage amount data” include various data whose use amounts and storage amounts can be substantially calculated as well as use amounts and storage amounts themselves.

The term “statutes” is a wide concept including laws, order, regulations, rules, treaties, and the like.

The term “regulated amount” is used to define an amount that needs to be managed and reported according to a statute, e.g., a release amount, transfer amount, or the like based on the PRTR law.

The term “process” is used in a general sense. However, in a production line, processing line, and the like, the release rates/transfer rates of regulated substances may be influenced by the characteristics of manufacturing facilities and various apparatuses, or the sequence of tasks, the number of steps, or the like, and hence they are distinguished from each other. Therefore, “process” is a concept including lines, tasks, steps, and other elements that influence release rates/transfer rates.

The term “name” includes a code and number.

The term “calculation” is a concept that includes all cases where the CPU obtains values by accessing any hardware resources such as a memory, e.g., a case where the CPU obtains a value by looking up a table, as well as a case where a value is obtained by calculation.

The term “management number” indicates a number to be added for classification, management, or the like, and includes a chemical abstract service (to be referred to as “CAS” hereinafter) code (to be referred to as a “CAS code” hereinafter), which is a unified code for chemical substances used worldwide.

According to the present invention, there is provided an environmental management support system which calculates a release or transfer amount of a chemical substance contained in a target article, characterized by comprising basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes, data input means having a use amount input section which input use amount data about a target article in each of the processes and calculates a release or transfer amount of the chemical substance contained in the target article in a predetermined period for each of the processes by using the input data and each information stored by the basic information registration means, and means for outputting the release or transfer amount of the chemical substance calculated by the data input means for each of the processes.

According to the present invention, there is provided another environmental management support system which calculates a release or transfer amount of a chemical substance contained in a target article, characterized by comprising basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes, data input means having a use amount input section which input use amount data about a target article in each of the processes and calculates a release or transfer amount of the chemical substance contained in the target article in a predetermined period for each of the processes by using the input data and each information stored by the basic information registration means, and a transfer amount input section which allows the calculated release or transfer amount to be corrected/input, corrects, when correcting/inputting operation is performed, the corresponding release or transfer rate information, and allows the corrected release or transfer rate information to be identified, or a correction log is allowed to be displayed when the release or transfer rate information is to be displayed, and means for outputting the release or transfer amount of the chemical substance calculated or corrected by the data input means for each of the processes.

According to the present invention, there is provided a server in an environmental management support system which calculates a release or transfer amount of a chemical substance contained in a target article by using a computer system in which a terminal and the server are connected to each other through a communication network, characterized by comprising basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes, data input means having a use amount input section which input use amount data about a target article in each of the processes from the terminal and calculates a release or transfer amount of the chemical substance contained in the target article in a predetermined period for each of the processes by using the input data and each information stored by the basic information registration means, and a transfer amount input section which allows the calculated release or transfer amount to be corrected/input, corrects, when correcting/inputting operation is performed, the corresponding release or transfer rate information, and allows the corrected release or transfer rate information to be identified, or a correction log is allowed to be displayed when the release or transfer rate information is to be displayed, and means for outputting the release or transfer amount of the chemical substance calculated or corrected by the data input means for each of the processes, wherein the respective means can activated independently of each other.

In the above server in the environmental management support system, the terminal includes a mobile terminal apparatus, and at least the data input means of the respective means is configured to input data by using the mobile terminal apparatus.

According to the present invention, there is provided a computer-readable storage medium storing a program for calculating a release or transfer amount of a chemical substance contained in a target article, characterized in that the program can execute basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes, data input means having a use amount input section which input use amount data about a target article in each of the processes and calculates a release or transfer amount of the chemical substance contained in the target article in a predetermined period for each of the processes by using the input data and each information stored by the basic information registration means, and a transfer amount input section which allows the calculated release or transfer amount to be corrected/input, corrects, when correcting/inputting operation is performed, the corresponding release or transfer rate information, and allows the corrected release or transfer rate information to be identified, or a correction log is allowed to be displayed when the release or transfer rate information is to be displayed, and means for outputting the release or transfer amount of the chemical substance calculated or corrected by the data input means for each of the processes.

According to the present invention, there is provided an environmental management support method of calculating a release or transfer amount of a regulated substance, of chemical substances contained in a target article of a user, which is designated as a management or report target by a statute, by using a computer system in which a terminal on a user side and a server on an environmental management support company side are connected to each other through a communication network, and providing a calculation result for a user, characterized by comprising steps of storing statute-associated information including information for specifying a regulated substance in a storage device of the server, storing, in the storage device of the server, target-article-associated information including information for specifying a target article containing a chemical substance, information for specifying the chemical substance, and a content of the chemical substance, determining, by using the statute-associated information and the target-article-associated information stored in the respective steps, whether the chemical substance is a regulated substance, and storing information for specifying the target article, information for specifying a regulated substance contained in the target article, and a content of the regulated substance as regulated-substance-associated information in correspondence with each other in the storage device of the server, storing identification information of at least one process including a plurality of tasks and release or transfer rate information of a regulated substance in each of the processes in the storage device of the server, outputting, to the terminal on the user side, a display to prompt the user to input use amount data of a target article in each of the processes, receiving use amount data input to the terminal on the user side through a communication network, calculating a release or transfer amount of a regulated substance contained in a target article in each of the processes in a predetermined period on the basis of the received use amount data and the respective pieces of information stored in the storage device of the server, transmitting the calculated release or transfer amount information to the terminal on the user side, outputting, to the terminal on the user side, a display to prompt the user to correct/input the transmitted release or transfer amount information, receiving the release or transfer amount information corrected and input to the terminal on the user side through a communication network, correcting the corresponding release or transfer rate stored in the storage device on the basis of the received release or transfer amount, and in transmitting release or transfer rate information to the terminal on the user side, allowing the corrected release or transfer rate information to be identified or transmitting the corrected release or transfer rate information, together with a correction log display, to the terminal on the user side.

According to the present invention, there is provided another environmental management support method of calculating a release or transfer amount of a chemical substance contained in a target article of a user by using a computer system in which a terminal on a user side and a server on an environmental management support company side are connected to each other through a communication network, and providing a calculation result for a user, characterized by comprising steps of outputting, to the terminal on the user side, a display to prompt the user to input basic information including information for specifying the target article, information for specifying a predetermined chemical substance contained in the target article, content information of the chemical substance, identification information of at least one process including a plurality of tasks, and release or transfer rate information of the chemical substance for each of the processes, receiving the basic information input to the terminal on the user side through a communication network and storing the information in a storage device of the server, outputting, to the terminal on the user side, a display to prompt the user to input use amount data of a target article in each of the processes, receiving use amount data input to the terminal on the user side through the communication network, calculating a release or transfer amount of the chemical substance contained in the target article in each of the processes in a predetermined period on the basis of the received use amount data and the respective pieces of information stored in the storage device of the server, outputting, to the terminal on the user side, a display to prompt the user to correct/input the transmitted release or transfer amount information, receiving the release or transfer amount information corrected and input to the terminal on the user side through the communication network, correcting the corresponding release or transfer rate stored in the storage device on the basis of the received release or transfer amount, and in transmitting release or transfer rate information to the terminal on the user side, allowing the corrected release or transfer rate information to be identified or transmitting the corrected release or transfer rate information, together with a correction log display, to the terminal on the user side.

The above environmental management support method is characterized by further comprising a step of transmitting consultation information based on the release or transfer amount data in each of the processes to the terminal on the user side.

According to the present invention, tasks in each work associated with environmental management can be simplified by dividing the function for environmental management in accordance with the work operations. More specifically, the present invention is configured to divide the overall system into functions for the respective management work operations in consideration of the fact that tasks required for environmental management are not completed within one department of an establishment but include a plurality of management work operations. This makes it possible to simplify data registration.

More specifically, the overall system is roughly divided into “basic information registration” which is an UI (User Interface) function corresponding to the work to be done by environmental management staff or a person in charge of environmental management who has an expert knowledge about environmental management, “use amount data or storage amount data input operation” which is an UI function corresponding to the work to be done by a field worker in charge who has no expert knowledge about environmental management and engages in manufacture/processing/storage/transportation work, and “summation result output operation” which is an UI function corresponding to the analysis work for recording/reporting/improvements which is to be done by an establishment manager. This makes it possible to reduce tasks for the construction of a database for management by the expert staff for environmental management, in particular. In addition, since the field worker in charge of manufacture/processing/storage/transportation work is only required to input variable amounts such as use amounts and storage amounts, even the field worker in charge who has no expert knowledge about environmental management can perform input setting with relative ease.

In addition, a database for bringing chemical substances into correspondence with statutes can be properly set on the user side in the form of registration of basic information. With such an open database configuration, the user is only required to possess necessary minimum chemical substance data and statute data for management by himself/herself, but need not have any enormous data file. Even if establishments are distributed in a plurality of countries, since a file unique to each user can be defined, voluntary management can be performed. Furthermore, a search function based on a general, basic technique will suffice; no special search function is required.

Note that the acceptance amount, use amount, disposal amount, and the like of a chemical substance can be managed by an organization such as a section or department that handles the chemical substance. With regard to PRTR transfer amounts, however, since the transfer rates of chemical substances to the environment, e.g., the air, public water areas, drainage, and soil, vary depending on the characteristics of manufacturing facilities and apparatuses used in organizations, management needs to be performed in accordance with these variations. In order to perform management in accordance with the differences in transfer rate between these facilities and apparatuses, transfer amounts are calculated in each process. According to the present invention, a user is only required to input the use amounts of chemical substances in each process, and PRTR transfer amounts are automatically totalized on the basis of the input use amount data.

In addition, a computer system is formed into a client-server system constituted by a client and server, and is designed to input a user certificate every time each of the basic information registration means, data input means, and summation result output means is activated. This allows each person in charge to activate only a necessary functional section by inputting a user certificate in each of different types of works, thus preventing the user from activating any unnecessary functional section. In addition, while the function for environmental management is divided, the constructed database can be protected, thus realizing excellent reliability. Furthermore, if the client includes a mobile terminal apparatus, and at least the data input means of the respective means described above is configured to input data by using the mobile terminal apparatus, a field worker in charge who engages in manufacture/processing/storage/transportation work can easily input data by using the mobile terminal apparatus even in a site where no PC exists. This can improve the efficiency of data input operation.

The basic information registration means includes an establishment information registration section which stores information about an establishment, including the establishment name, the location of the establishment, and the contact of the establishment, a target article registration section which stores information about a target article, including the target article name and the names and contents of regulated substances contained in the target article, an associated statute registration section which stores information about statutes, including the names of statutes associated with the establishment, and a regulated substance registration section which stores information about regulated substances, including the names, reference numbers, or unified codes (CAS codes) for chemical substances used worldwide of regulated substances handled in the establishment, and the names of statutes associated with the regulated substances, and if a compound handled in the establishment contains a regulated substance, information about the compound, including the names of the compound and regulated substance, the content of the regulated substance in the compound, and the names of statutes associated with the regulated substance. The respective sections store the respective pieces of information described above. With this arrangement, the establishment information registration section, target article registration section, associated statute registration section, and regulated substance registration section are independently prepared and configured to store pieces of information independently. Even if part of such information is unclear, since only clear information can be registered independently, each registration task is simplified, and task sharing is facilitated.

With regard to the regulated substances contained in a compound, by registering the contents of the regulated substances in the compound and associated statutes, the transfer amounts of regulated substances in the compound can be easily grasped and managed in compliance with laws.

In addition, the basic information registration means has a transfer rate setting section which can set the release rate or transfer rate of a regulated substance in each process, and the data input means is configured to calculate the release or transfer amount of regulated substance by using the release or transfer rate set by the transfer rate setting section. In addition, the transfer rate setting section is configured to set the release or transfer rates of regulated substances for each target article. With this arrangement, by setting the release rates/transfer rates of regulated substances in each process, the release amounts/transfer amounts of regulated substances can be easily calculated by using the release rates/transfer rates. This makes it easy to manage the release amounts/transfer amounts of regulated substances in each process. By setting the release rates/transfer rates of regulated substances for each target article, in particular, the release amounts/transfer amounts of regulated substances can be precisely managed for each target article.

The data input means has a transfer amount input section which uses the release or transfer amount of regulated substance, as a default value, which is the value calculated on the basis of the release or transfer rate of the regulated substance set by the transfer rate setting section, and if the actual value of the release or transfer amount of regulated substance differs from the default value, corrects/inputs the default value into the actual value. If, therefore, the actual value of the release amount/transfer amount of regulated substance coincides with a default value, the user need not perform input operation. Only when the actual value differs from the default value, the user is required to correct the value. This facilitates an input task for the release amount/transfer amount of regulated substance. If an actual value differs from a default value, in particular, the user need not correct both the release rate/transfer rate and the release amount/transfer amount; when the user corrects one of the values, the other value is automatically corrected. This makes it possible to always keep coherence between the release rates/transfer rates and the release amounts/transfer amounts. Note that the transfer amount input section can correct/input the release or transfer rate of a regulated substance by using the release or transfer rate of the regulated substance set by the transfer rate setting section, and may be configured such that when the release or transfer rate of the regulated substance or the release or transfer amount of the regulated substance is corrected/input, the other value is automatically corrected/input.

In addition, when the system is started in normal operation, the data input means is activated first. With this arrangement, when the system is used in normal operation, use amount data can be immediately input by starting the data input means first. This eliminates the necessity to perform window switching and the like for function selection, and hence the input task for use amount data can be quickly started accordingly. In this manner, by giving high priority to use amount data input processing that is expected to be performed most frequently, the operation efficiency can be improved.

According to the above environmental management support method, programs are distributed to only the users who have input user information so as to collect charges from them by using a communication network. This allows a program providing service for the realization of the environmental management support system of the present invention to be easily established as a network business. In addition, by making charges by transmitting consultation information, a consultation service can be combined with a program providing service. This makes it possible to further expand the range of users.

In addition, according to this environmental management support method, when the use amount data or storage amount data of a target article is input by a user, necessary basic information such as statutes and regulated substances contained in the target article is acquired separately, and the regulated amounts of regulated substances contained in the target article in a predetermined period are automatically calculated. This result can be provided for the user. When, therefore, a user only inputs the use amount data or storage amount data of a target article, even though he/she has no expert knowledge about statutes or grasps no gradient of the target article, he/she can easily acquire the result obtained by calculating the regulated amount of each regulated substance in a predetermined period. According to this method, even if no unique database is prepared, since necessary basic information may be acquired from another database or the like, the system configuration for providing services can be simplified; the practicality of the method is high.

As described above, according to the present invention, the release amounts/transfer amounts of chemical substances are calculated in each process, and the function of the system is divided into unit functions, i.e., basic information registration, data input operation, and summation result output operation, in accordance with the contents of work or the properties of data to be input, thereby reducing input errors and realizing efficient data input operation. This makes it possible to provide data effective for management/improvements.

### BRIEF DESCRIPTION OF THE SEVERAL VIEWS OF THE DRAWING

FIG. 1 is a block diagram showing the equipment configuration of an environmental management support system according to the first embodiment of the present invention;

FIG. 2 is a functional block diagram showing the overall arrangement of the environmental management support system in FIG. 1;

FIG. 3 is a flow chart showing an outline of the operation of the environmental management support system in FIG. 2;

FIG. 4 is a block diagram showing the relationship between the respective functional sections and information files in the environmental management support system in FIG. 2;

FIG. 5 is a flow chart showing a subroutine for PRTR transfer amount calculation processing in FIG. 3;

FIG. 6 is a view showing a window display for establishment information registration by an establishment information registration section in a basic information registration function of a common portion in the environmental management support system in FIG. 2;

FIGS. 7A and 7B are views showing window displays for associated statute registration by an associated statute registration section in the basic information registration section of the common portion in the environmental management support system in FIG. 2, in which FIG. 7A shows a window display for statute/regulation registration, and FIG. 7B shows a window display for classification registration;

FIGS. 8A and 8B are views showing window displays for chemical substance registration by a chemical substance registration section in the basic information registration section of the common portion in the environmental management support system in FIG. 2, in which FIG. 8A shows a window display for a chemical substance list, and FIG. 8B shows a window display for chemical substance information input operation;

FIGS. 9A and 9B are views showing window displays for chemical substance registration by a chemical substance registration section in the basic information registration section of the common portion in the environmental management support system in FIG. 2, in which FIG. 9A shows a window display for associated statute/regulation setting operation, and FIG. 9B shows a window display for PRTR setting operation;

FIGS. 10A and 10B are views showing window displays for organization registration by an organization registration section in the basic information registration section of the common portion in the environmental management support system in FIG. 2, in which FIG. 10A shows a window display for an organization name list, and FIG. 10B shows a window display for organization name input operation;

FIGS. 11A and 11B are views showing window displays for target article registration by a target article registration section in the basic information registration section of the common portion in the environmental management support system in FIG. 2, in which FIG. 11A shows a window display for a target article list, and FIG. 11B shows a window display for target article information input operation;

FIGS. 12A and 12B are views showing window displays for to-be-used target article setting operation by a to-be-used target article setting section in an organic-specific basic information registration section in the environmental management support system in FIG. 2, in which FIG. 12A shows a window display for a to-be-used target article list, and FIG. 12B shows a window display for to-be-used target article setting operation;

FIG. 13 is a view showing a window display for use amount setting operation by a use amount plan setting section in the organic-specific basic information registration section in the environmental management support system in FIG. 2;

FIG. 14 is a view showing a window display for PRTR use rate setting operation by a PRTR transfer rate setting section in the organic-specific basic information registration section in the environmental management support system in FIG. 2;

FIG. 15 is a view showing a window display for use amount input operation by a use amount input section in the organic-specific basic information registration section in the environmental management support system in FIG. 2;

FIG. 16 is a view showing a window display for PRTR transfer amount input operation by a PRTR transfer amount input section in the organic-specific basic information registration section in the environmental management support system in FIG. 2;

FIG. 17 is a view showing a window display for organization-specific summation result display operation by an organization-specific summation result display section in a summation result output section in the environmental management support system in FIG. 2;

FIG. 18 is a view showing a window display for monthly summation result display operation by a monthly summation result display section in the summation result output section in the environmental management support system in FIG. 2;

FIG. 19 is a view showing a window display for chemical-substance-specific summation result display operation by a chemical-substance-specific summation result display section in the summation result output section in the environmental management support system in FIG. 2;

FIG. 20 is a view showing a window display for PRTR summation result display operation by a PRTR summation result display section in the summation result output section in the environmental management support system in FIG. 2;

FIGS. 21A and 21B are views showing window displays for report setting operation by a report setting section in the report setting/outputting section of the environmental management support system shown in FIG. 2, in which FIG. 21A shows a window display of a registration report list, and FIG. 21B shows a window display for report data input operation;

FIG. 22 is a view showing a window display for report output operation by a report output section in the report setting/outputting section of the environmental management support system in FIG. 2;

FIG. 23 is a view showing a window display for PRTR summation result display operation by the report output section in the report setting/outputting section of the environmental management support system in FIG. 2;

FIG. 24 is a view showing a window display in a case where part of the contents of the PRTR summation result display in FIG. 23 is expressed in the form of a graph for voluntary management;

FIG. 25 is a flow chart showing a main routine for a case where distributed data processing is performed by the environmental management support system in FIG. 2;

FIG. 26A is a flow chart showing a subroutine for basic information registration processing in FIG. 25, FIG. 26B is a flow chart for data input processing, and FIG. 26C is a flow chart showing a subroutine for summation result output processing;

FIG. 27 is a flow chart showing a main routine for a case where input processing of use amount data is immediately started by the environmental management support system in FIG. 2;

FIG. 28A is a flow chart showing a subroutine for basic information registration processing in FIG. 27, and FIG. 28B is a flow chart showing summation result output processing in FIG. 28B;

FIG. 29 is a flow chart showing a procedure for accepting external data by the environmental management support system in FIG. 2;

FIG. 30 is a flow chart showing a procedure for basic information registration in a case where the environmental management support system in FIG. 2 performs distributed data processing by using external data for only part of basic information;

FIG. 31A is a flow chart showing a procedure for data input operation in a case where the environmental management support system in FIG. 2 performs distributed data processing by using external data for only part of basic information, and FIG. 31B is a flow chart showing a procedure for summation result output operation;

FIG. 32 is a functional block diagram showing the overall arrangement of an environmental management support system according to the second embodiment of the present invention;

FIG. 33 is a flow chart showing an outline of the operation of the environmental management support system in FIG. 32;

FIG. 34 is a flow chart showing a procedure for providing consultation information by using the environmental management support system in FIG. 32;

FIG. 35 is a block diagram showing an overall environmental management support system added to a drug management system;

FIG. 36 is a block diagram showing an overall drug/environmental management support system formed as a networked system;

FIG. 37 is a view showing a window display on an MSDS information registration section;

FIG. 38 is a block diagram showing an overall environmental management support system connected to an OCR system;

FIG. 39 is a view showing a window display of an MSDS search result;

FIG. 40 is a view showing a window display on a memo input section;

FIG. 41 is a view showing a window display on a use amount log display section;

FIG. 42 is a view showing a window display for acceptance/use amount setting operation;

FIG. 43 is a view showing a window display on a PRTR transfer rate setting section;

FIG. 44 is a view showing a window display on a PRTR target group setting section;

FIG. 45 is a functional block diagram showing the overall arrangement of a measurement value management function;

FIG. 46 is a flow chart showing an outline of the operation of the measurement value management function; and

FIG. 47 is a view showing a window display for displaying a release amount summation result.

### DETAILED DESCRIPTION OF THE INVENTION

The embodiments to which the present invention is applied will be described in detail below with reference to the views of the accompanying drawing. For the sake of simplicity, the same reference numerals denote the same constituent elements throughout the views of the drawing.

[First Embodiment]

[Equipment Configuration]

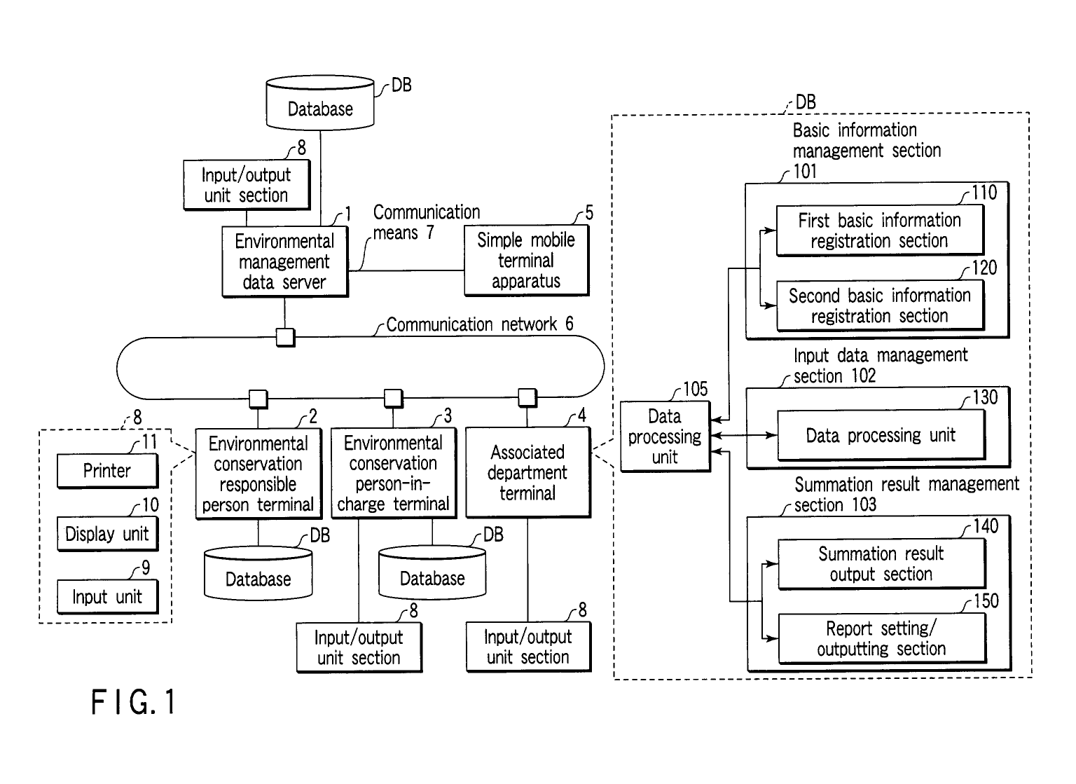

FIG. 1 is a block diagram showing the equipment configuration of an environmental management support system according to the first embodiment.

As shown in FIG. 1, this system is formed by a client-server system. An environmental management data server 1 and a plurality of clients are connected to each other through a communication network 6 and communication means 7. The plurality of clients include an environmental conservation responsible person terminal 2, environmental conservation person-in-charge terminal 3, associated department terminal 4, and simple mobile terminal apparatus 5. Each of the environmental conservation responsible person terminal 2, environmental conservation person-in-charge terminal 3, and associated department terminal 4 is formed by one PC or a plurality of PCs connected to a communication network.

The environmental management data server 1 and the plurality of PC2 to PC4 each have an input/output unit section 8. The input/output unit section 8 includes an input unit 9 for inputting environmental management data and operating various functions, a display unit 10 for displaying output data and the like, a printer 11 for outputting summation results and reports, and the like. The input unit 9 has a keyboard and mouse (not shown), by which an operation or data input flow is selected by using a window (not shown) on the display unit 10.

The simple mobile terminal apparatus 5 incorporates an input unit section and display unit section (not shown), and is connected to the environmental management data server 1 through the communication means 7 by radio.

The environmental management data server 1 and the plurality of clients each have a database DB. Each database DB holds a program constituted by three management sections, namely a basic information management section (basic information registration means) 101, input data management section (data input means) 102, and summation result management section (summation result output means) 103.

[System Configuration]

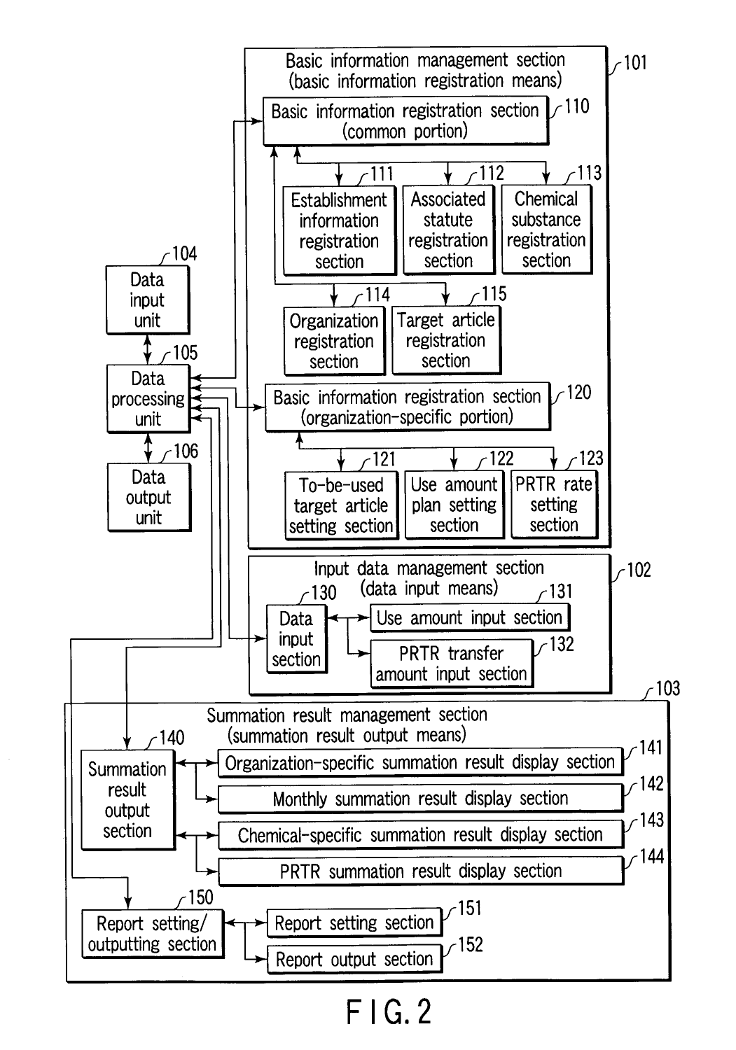

FIG. 2 is a functional block diagram showing the overall configuration of this system. As shown in FIG. 2, this system includes the three management sections, i.e., the basic information management section (basic information registration means) 101, input data management section (data input means) 102, and summation result management section (summation result output means) 103. The program for executing these functions is executed by hardware including a data input unit 104, data processing unit 105, and data output unit 106.

The basic information management section 101 has a first basic information registration section 110 and second basic information registration section 120. The input data management section 102 has a data input section 130. The summation result management section 103 has a summation result output section 140 and report setting/outputting section 150.

The first basic information registration section 110 corresponds to the work done by environmental management staff having an expert knowledge about environmental management. More specifically, the first basic information registration section 110 has at least an establishment information registration section 111 for registering information about facilities and establishment that handle chemical substances, an associated statute registration section 112 for registering associated statues concerning target chemical substances, a chemical substance registration section 113 for registering information about the target chemical substances, and a target article registration section 115 for registering information about target articles (handled products) made of these chemical substances. If target articles vary in each manufacturing or processing process, an organization registration section 114 is added to register an organization configuration and, for each “process” which is equal to or more than one line managed by an organization as a minimum unit, the name of the organization as the minimum unit.

The second basic information registration section 120 is added to register organization-specific basic information, when the organization registration section 114 is added. The second basic information registration section 120 has a to-be-used target article setting section 121 for setting a target article to be used in each process in each organization, a use amount plan setting section 122 for setting the planned value of the amount of target article used in each process in each organization, and a PRTR transfer rate setting section 123 for setting chemical substances as PRTR targets or the transfer rates (PRTR transfer rates) of chemical substances including PRTR targets in each step in each organization.

The data input section 130 corresponds to the work done by persons in charge of storage, manufacture, processing, and transportation. The data input section 130 manages only the variation amounts of target articles handled by persons in charge regardless of whether they have an expert knowledge about environmental management. The data input section 130 has a use amount input section 131 for inputting the amount of target article used in a predesignated unit, and a PRTR transfer amount input section 132 for inputting the actual transfer amounts (PRTR transfer amounts) of chemical substances as PRTR targets or chemical substances including PRTR targets by using the default values calculated on the basis of PRTR transfer rates.

The summation result output section 140 corresponds to the management work done by a facility or establishment manager. The summation result output section 140 calculates the transfer amounts of chemical substances as PRTR targets or chemical substance including PRTR targets contained in a target article on the basis of the use amount data of the target article input by the data input section 130 and the basic information registered by the first basic information registration sections 110 and 120. The summation result output section 140 then totalizes the calculated amounts under a predetermined condition and outputs the summation result. The summation result output section 140 has an organization-specific summation result display section 141 for displaying organization-specific summation results, a monthly summation result display section 142 for displaying monthly summation results, a chemical-specific summation result display section 143 for displaying chemical-specific summation results, and a PRTR summation result display section 144 for displaying organization-specific summation results obtained in a predetermined period of time.

The report setting/outputting section 150 corresponds to the report creation work for reports directed to government and municipal offices and voluntary management. The report setting/outputting section 150 has a report setting section 151 for making output settings for reports in accordance with statutes and the like, and a report output section 152 for outputting reports in set forms.

[System Operation]

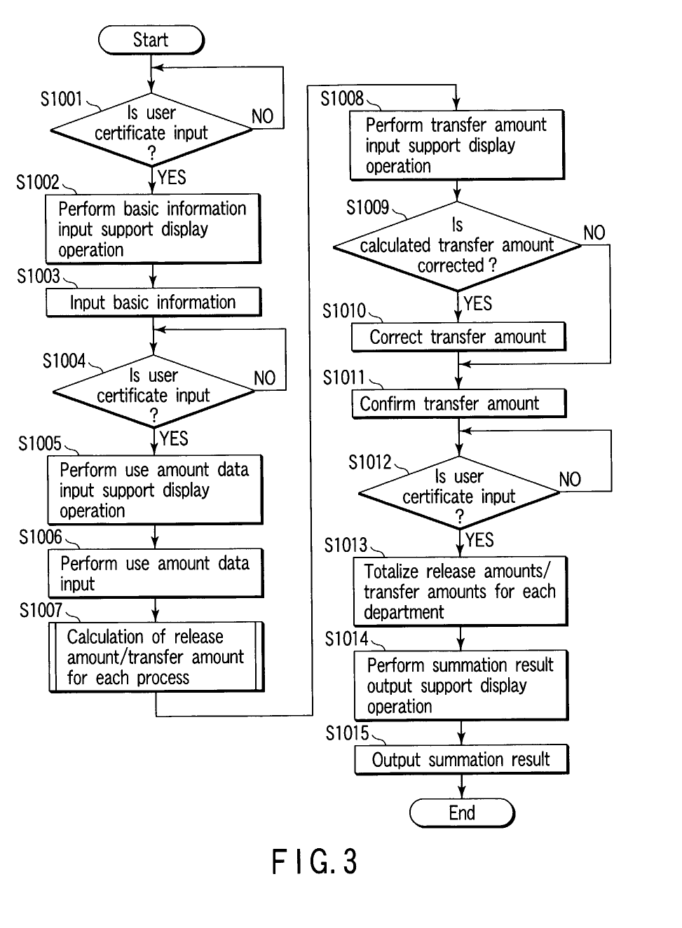

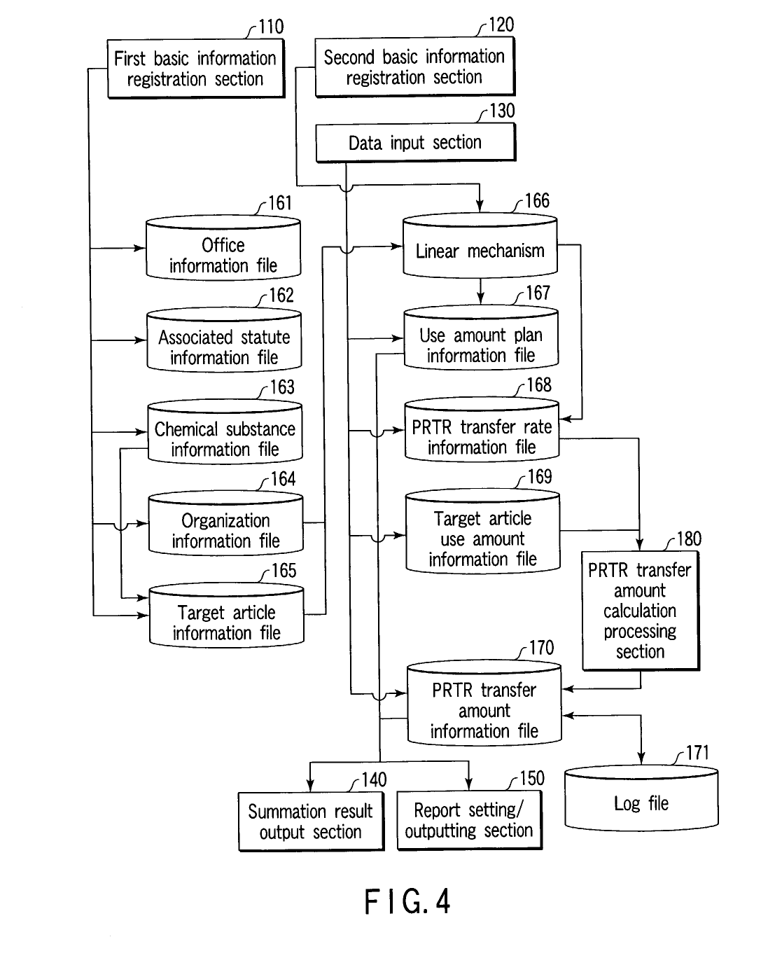

FIG. 3 is a flow chart schematically showing the operation performed by this system. FIG. 4 is a block diagram showing the relationship between the respective functional sections 110, 120, 130, 140, and 150 and information files 161 to 170. An outline of the operation of this system will be described below with reference to FIGS. 3 and 4.

As shown in FIG. 3, if it is determined that a user certificate is input (YES in step S1001), input support display operation is performed for basic information including a department name, one or more process identification names in the department, a target article name, the names of regulated substances contained in the target article, the contents of the regulated substances, and the like (step S1002). The basic information input from the user is then registered (step S1003).

In steps S1002 and S1003, the first basic information registration section 110 and second basic information registration section 120 perform basic information registration processing. More specifically, as shown in FIG. 4, the first basic information registration section 110 registers establishment information, associated statute information, chemical substance information, and organization information in the information files 161 to 164, respectively, and also registers the target article information obtained by using the chemical substance information in the article information file 165. After the to-be-used target article information is registered in the information file 166 by the second basic information registration section 120, the use amount plan information and PRTR transfer rate information obtained by using the to-be-used target article information are registered in the information files 167 and 168, respectively.

Assume that in registering process information, a plurality of task names and task contents are input first, and tasks in processes to be registered are selected from the plurality of tasks in the actual task order, thereby registering the task information, together with the process information. In this case, if the contents of a task or the task order differs from those registered, the corresponding process can be reliably identified as a different process. This makes it possible to easily and reliably perform management for each process.

Referring to FIG. 3, if it is determined that a user certificate is input (YES in step S1004), input support display for the use amount data of a target article in each process is performed (step S1005). The use amount data approved by the user is input (step S1006).

More specifically, in steps S1005 and S1006, as shown in FIG. 4, the use amount input section 131 of the data input section 130 performs use amount input processing to register target article use amount information in the target article use amount information file 169.

Subsequently, the release amounts/transfer amounts of PRTR target substances contained in the target article within a predetermined period of time are calculated on a process basis on the basis of the use amount data and basic information (step S1007). Input support display is then performed by setting the calculated release amounts/transfer amounts as default values (step S1008). If the user corrects the default values (YES in step S1009), the transfer amounts are corrected (step S1010), and the corrected values are confirmed as release amounts/transfer amounts (step S1011). If the user approves the default values without correcting them (NO in step S1009), the default values are confirmed as release amounts/transfer amounts without any change (step S1011).

A PRTR transfer amount calculation processing section 180 in FIG. 4 executes the processing in step S1007. The values calculated by the PRTR transfer amount calculation processing section 180 and confirmed in step S1011 are registered as PRTR transfer amount information in the PRTR transfer amount information file 170. Every time the PRTR transfer amount information file 170 is updated, the corresponding log information is accumulated in a log file 171.

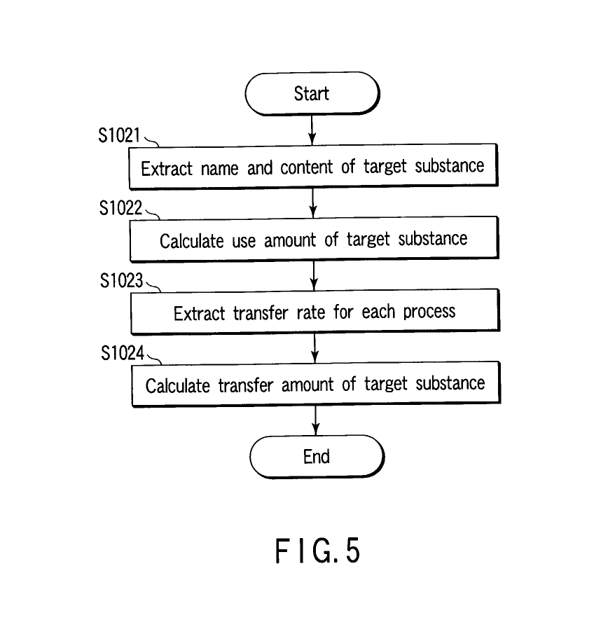

FIG. 5 is a flow chart showing the subroutine of PRTR transfer amount calculation processing (step S1007) done by the PRTR transfer amount input section 132 in FIG. 2 of the data input section 130 in FIG. 4. As shown in FIG. 5, the PRTR transfer amount input section 132 extracts the names and contents of PRTR target substances contained in the target article from the target article information file 165 (step S1021). The PRTR transfer amount input section 132 extracts the use amount of target article in each process from the target article use amount information file 169, and multiplies the use amount by the content of each PRTR target substance, thereby calculating the use amount of each PRTR target substance in each process (step S1022). The PRTR transfer amount input section 132 then extracts each transfer rate in each process from the PRTR transfer rate information file 168 (step S1023), and multiplies the use amount of PRTR target substance by the transfer rate in each process, thereby calculating the transfer amount of PRTR target substance in each process (step S1024).

Referring to FIG. 3, if it is determined that a user certificate is input (YES in step S1012), the calculated release amounts/transfer amounts in the respective processes in each department are added together (step S1013) to totalize the release amounts/transfer amounts of each regulated substance in each department. Output support display for the summation results is performed (step S1014), and the summation results are output in the condition and form designated by the user (step S1015).

The processing in step S1012 to step S1015 corresponds to the summation result output processing performed by the summation result output section 140. That is, as shown in FIG. 4, the summation result output section 140 performs the above summation result output processing by using the use amount plan information file 167, target article use amount information file 169, and PRTR transfer amount information file 170.

FIG. 3 shows as if the basic information registration processing, data input processing, and summation result output processing were performed as a series of operations. However, this operation sequence indicates only the usage relationship between data but does not correspond to the actual operation sequence. In practice, these three types of processes are often performed separately as independent tasks in different types of work.

Although not shown in FIG. 3, if a report output request is input from the user, report output processing is performed by the report setting/outputting section 150 in FIG. 4.

[Operation of Each Function]

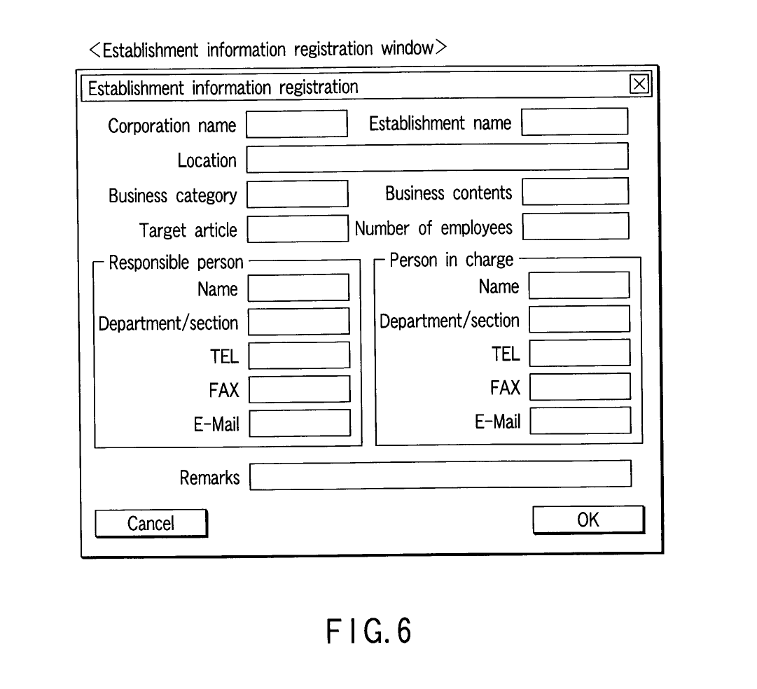

FIGS. 6 to 24 are views showing the specific window displays for the respective management support operations by the respective functional sections. The detailed operations of the first basic information registration section 110, second basic information registration section 120, data input section 130, summation result output section 140, and report setting/outputting section 150 will be sequentially described below with reference to FIGS. 6 to 24.

[Operation of Basic Information Registration Section for Common Portion]

As described above, since the first basic information registration section 110 is a section corresponding to the work done by environmental management staff having an expert knowledge about environmental management, support display operations for the execution of establishment information registration, associated statute registration, chemical substance registration, organization registration, and target article registration are performed for the environmental management staff having such expert knowledge, as shown in FIGS. 6 to 11B. When pieces of information are input or designated by the staff having the expert knowledge, the pieces of information are registered.

FIG. 6 is a view showing a window display for establishment information registration performed by the establishment information registration section 111 in the first basic information registration section 110.

As shown in FIG. 6, the establishment information registration section 111 performs support display operation to make the user input at least a corporation/group name, location, business contents, and contact including the name of a responsible person or person in charge. When such data are input by the user, the establishment information registration section 111 registers the data in the establishment information file 161 like the one shown in FIG. 4. Note that these data will be used in the future as basic data for the creation of a report according to associated statutes.

In addition to the above basic data, a business category, the number of works, main target articles, miscellaneous item, and the like may by set as reference information by the establishment information registration section 111. The window display in FIG. 6 exemplifies the columns for making the user input these pieces of reference information in addition to the columns for making the user to input the above basic data.

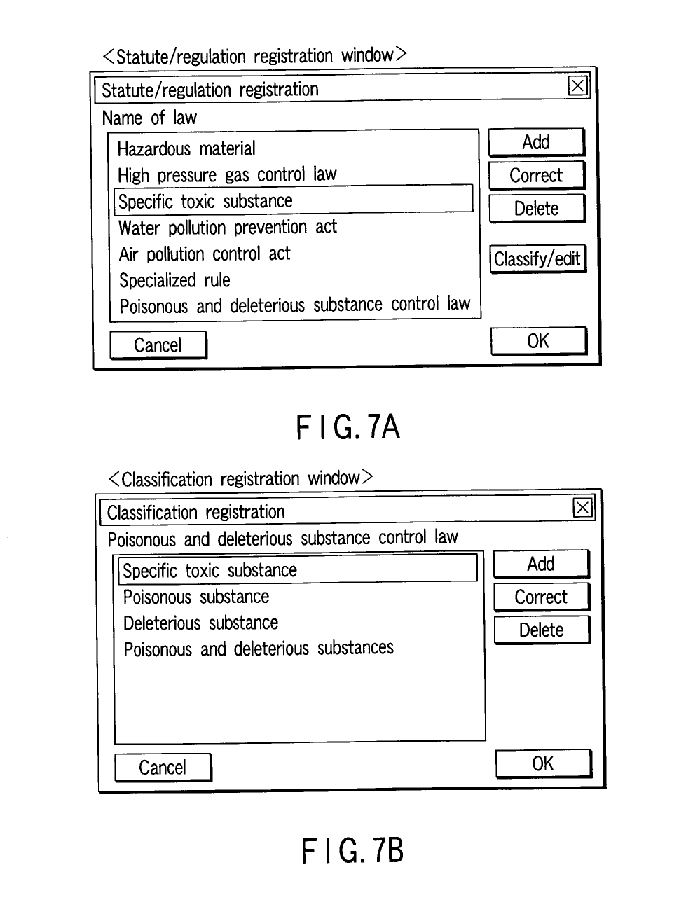

FIGS. 7A and 7B are views showing window displays for associated statute registration performed by the associated statute registration section 112 in the first basic information registration section 110.

As shown in FIG. 7A, the associated statute registration section 112 performs support display operation to make the user designate the names of a law, regulation, treaty, management rule imposed by the corporation by itself, or the like associated with a chemical substance handled by the establishment. The data of the statute or the like designated by the user is then registered in the associated statute information file 162.

In addition to the above name of a statute or the like, the associated statute registration section 112 may allow the user to set the classification information of an associated statute and its abbreviated name, as shown in FIG. 7B.

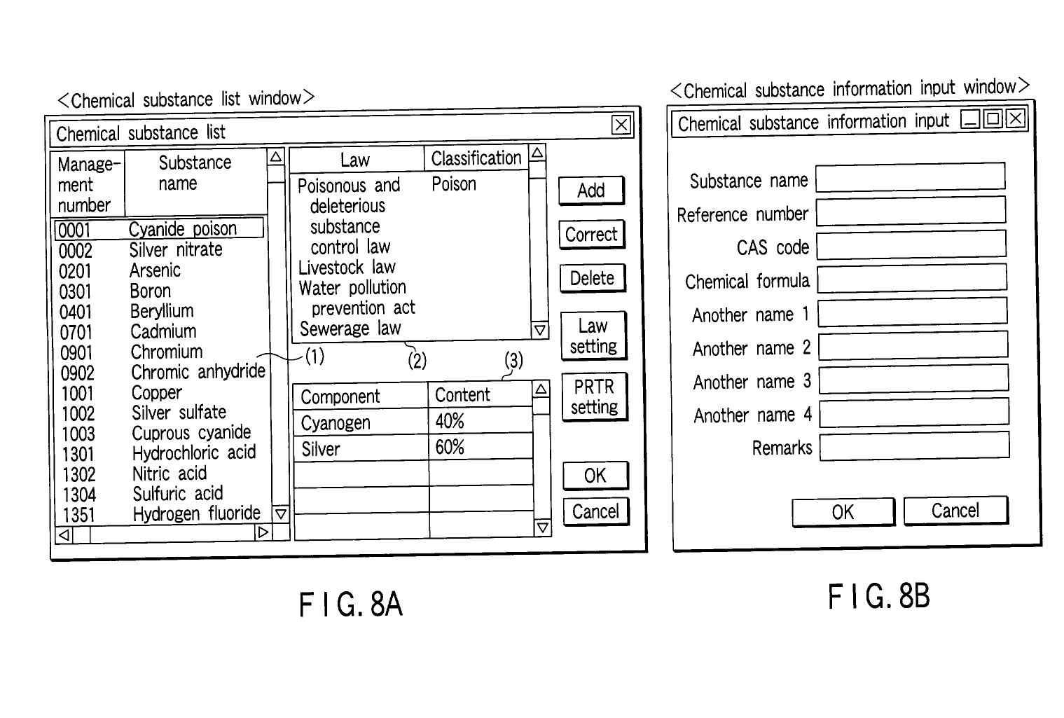

FIGS. 8A and 8B are views showing window displays for chemical substance registration performed by the chemical substance registration section 113 in the first basic information registration section 110.

As shown in FIGS. 8A and 8B, the chemical substance registration section 113 performs support display operation to make the user designate at least the name of a chemical substance contained in a target article handled by the establishment and a management number or CA step S code, and registers the data designated by the user in the chemical substance information file 163 like the one shown in FIG. 4.

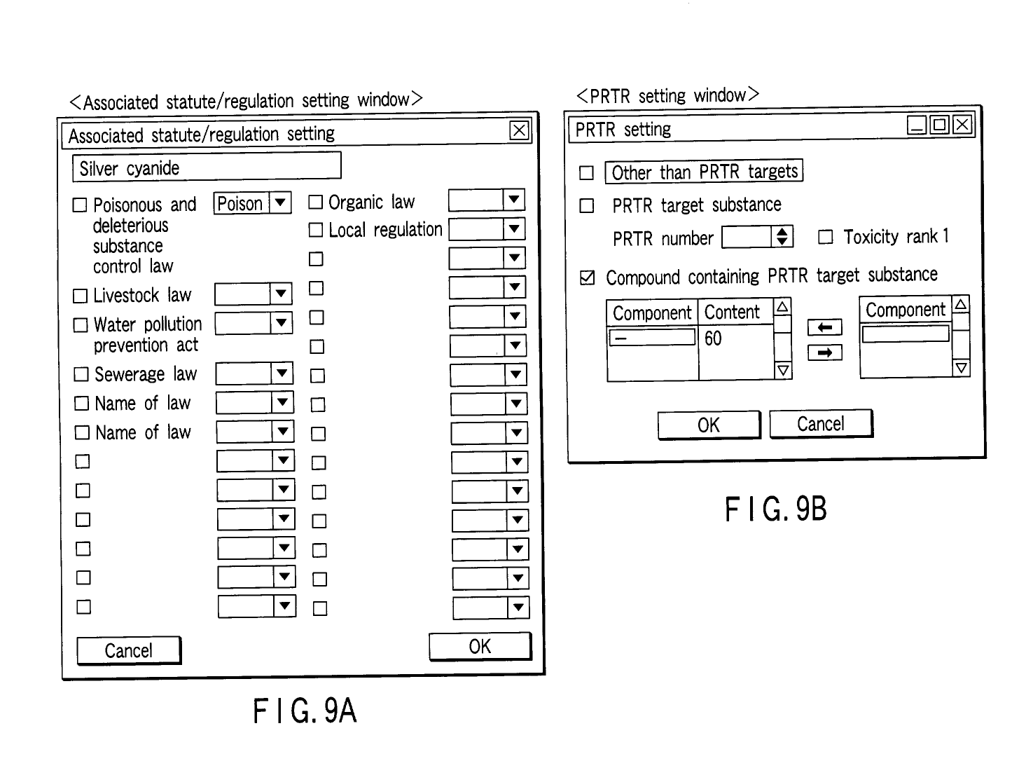

As shown in FIG. 9A, the chemical substance registration section 113 may bring each target chemical substance into correspondence with a plurality of associated statutes that regulate the chemical substance. In this case, target associated statutes may be arbitrarily selected from the associated statutes registered by the associated statute registration section 112 in advance.

If a target chemical substance is a PRTR target, a check mark indicating a PRTR target, a PRTR number, a toxicity rank, and the like may be registered, as shown in FIG. 9B. If this chemical substance contains a JPRTR target substance, a PRTR target substance and its content may be selected from a list of PRTR target substances and set/registered. In this case, as a list of PRTR substance, only information set as PRTR substances may be extracted from the information registered by the chemical substance registration section 113. In addition, as shown in FIG. 8B, the chemical substance registration section 113 may allow the user to set a chemical formula, another name, a miscellaneous item, and the like as reference information.

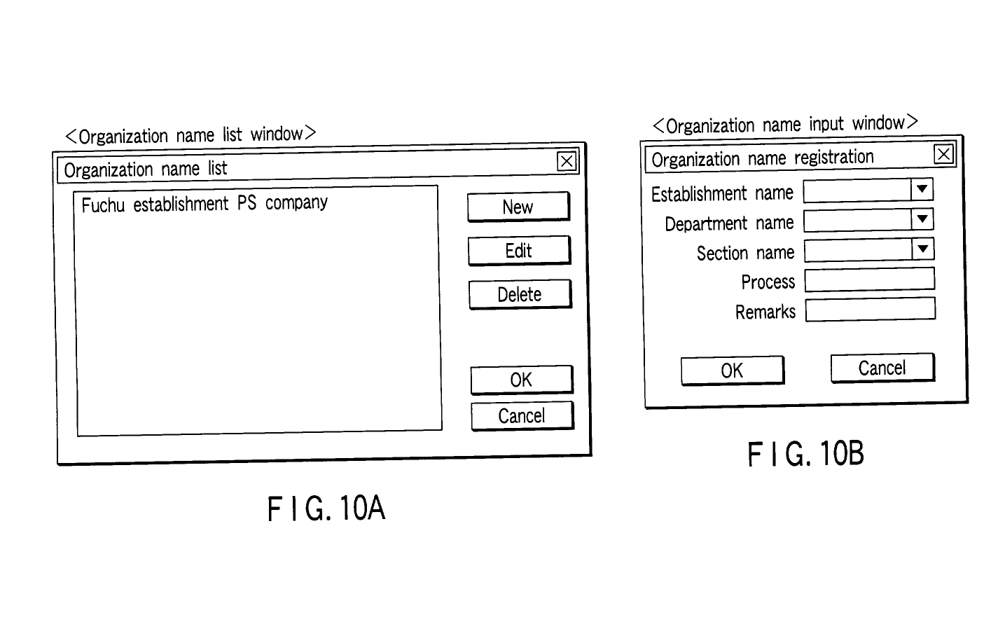

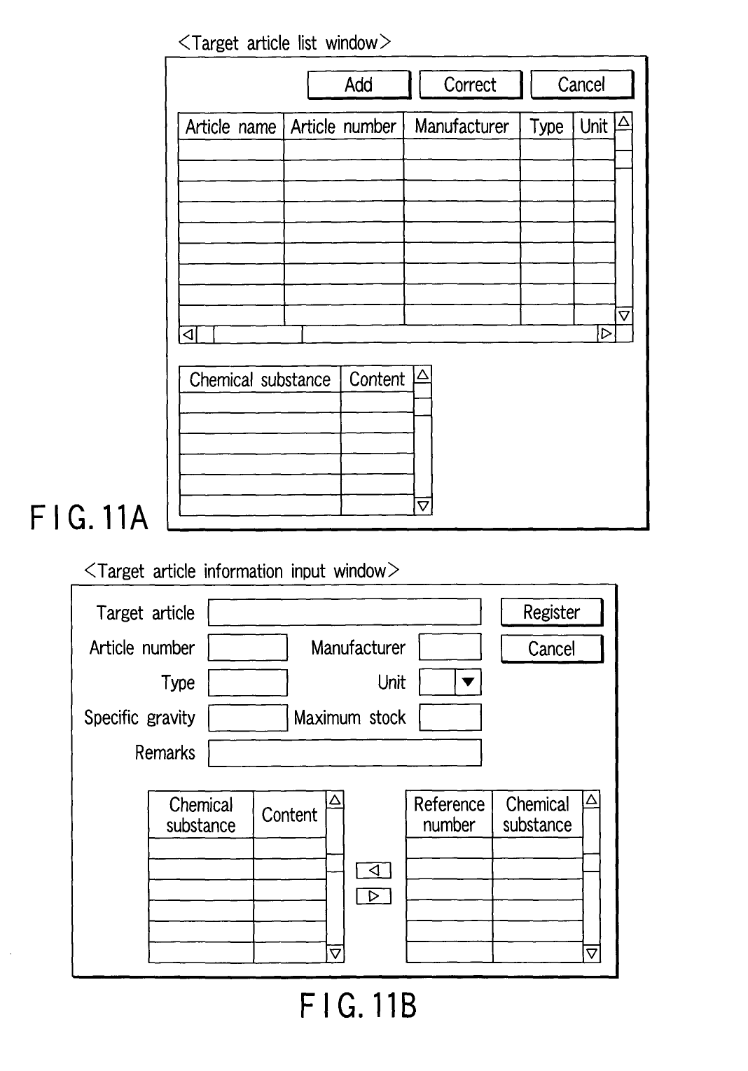

FIGS. 10A to 11B are views showing a window display for organization registration performed by the organization registration section 114 in the first basic information registration section 110 and a window display for target article registration performed by the target article registration section 115.

As shown in FIG. 10B, if target articles differ with manufacturing or working processes, the organization registration section 114 performs support display operation to make the user input at least an organization configuration and the name of an organization as the minimum unit for each process constituted by one or more lines managed by the minimum organization unit, and registers the data input from the user in the organization information file 164 like the one shown in FIG. 4.

In addition, as shown in FIG. 11A, the target article registration section 115 performs support display operation to make the user input at least the name of a target article, an article number of manufacturer, and the names and contents of a plurality of chemical substances contained in the target article, and registers the data input from the user in the target article information file 165 like the shown in FIG. 4. In this case, target chemical substances may be arbitrarily selected from the chemical substances registered by the chemical substance registration section 113 in advance. Furthermore, as shown in FIG. 11B, the target article registration section 115 may allow the user to set the physical unit and specific gravity of a target article, a miscellaneous item, and the like as reference information.

[Operation of Basic Information Registration Section for Organization-Specific Information]

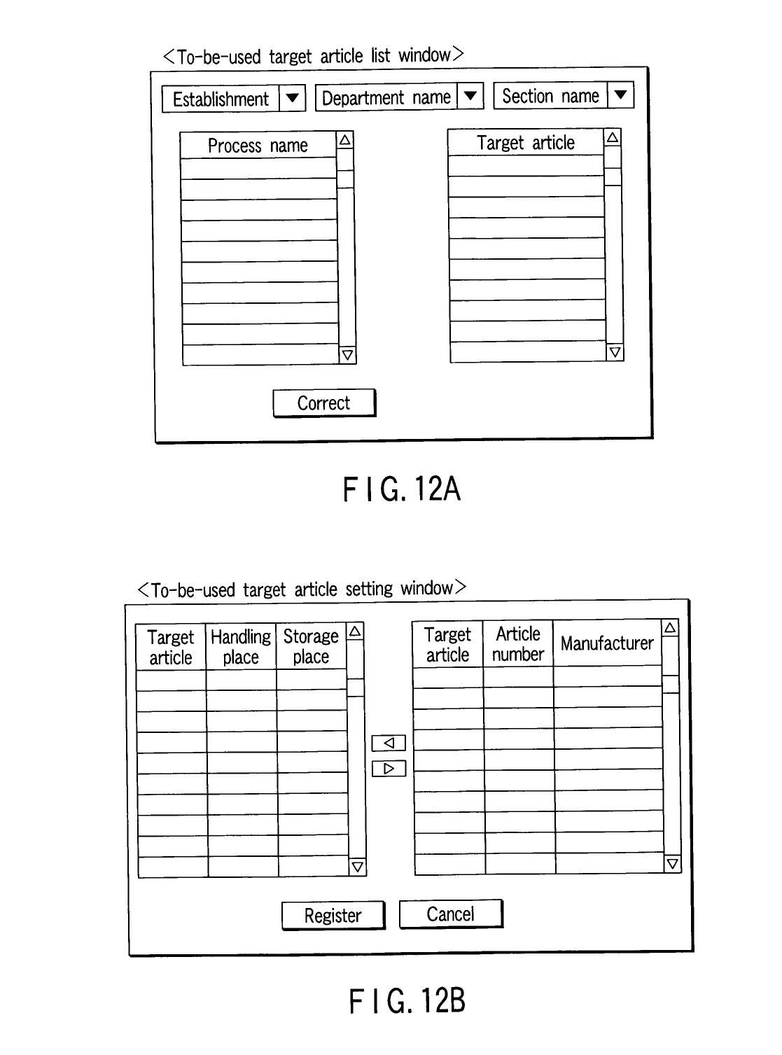

As described above, the second basic information registration section 120 is a section to be added to register organization-specific basic information when the organization registration section 114 is added. The second basic information registration section 120 performs support display operation to make the user perform to-be-used target article setting, use amount plan setting, and PRTR transfer rate setting like those shown in FIGS. 12A to 14. When the user inputs or designates corresponding pieces of information, the second basic information registration section 120 registers the pieces of information.

FIGS. 12A and 12B are views showing window displays for to-be-used target article setting performed by the to-be-used target article setting section 121 in the second basic information registration section 120.

As shown in FIG. 12A, the to-be-used target article setting section 121 performs support display operation to make the user to input at least the name of a target article to be used in each process managed by the minimum organization unit, and registers the data input from the user in the to-be-used target article information file 166 like the one shown in FIG. 4.

As shown in FIG. 12B, the to-be-used target article setting section 121 may allow the user to set the working place and storage place of a target article or the article number or manufacturer of the target article.

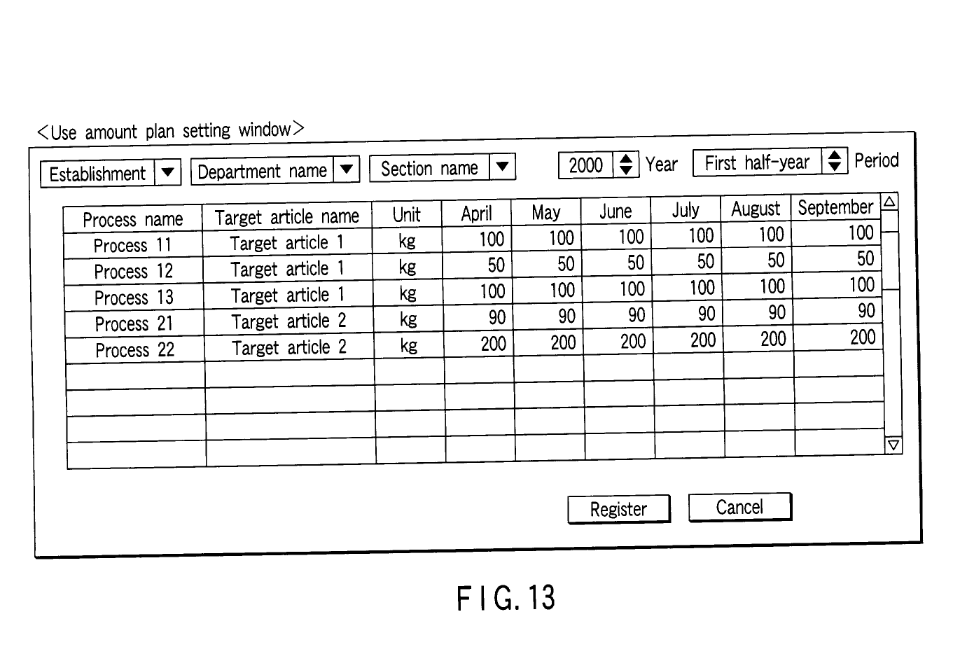

FIG. 13 is a view showing a window display for use amount plan setting performed by the use amount plan setting section 122 in the second basic information registration section 120.

As shown in FIG. 13, the use amount plan setting section 122 performs support display operation to make the user input the use amount unit and planned value of a target article used in each process managed by the minimum organization unit, and registers the data input from the user in the use amount plan information file 167 like the one shown in FIG. 4.

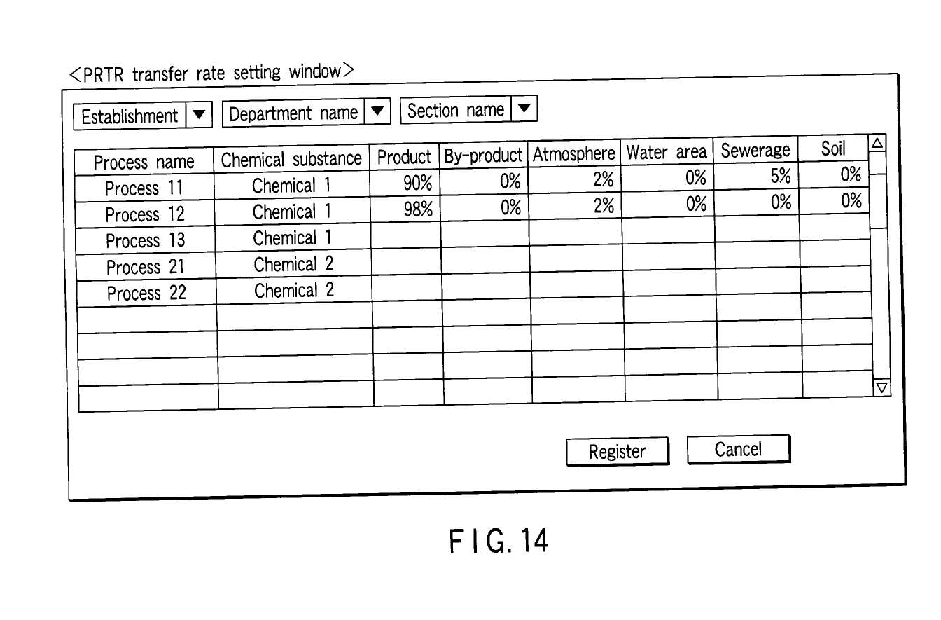

FIG. 14 is a view showing a window display for PRTR transfer rate setting performed by the PRTR transfer rate setting section 123 in the second basic information registration section 120.

As shown in FIG. 14, the PRTR transfer rate setting section 123 performs support display operation to make the user input the basic transfer rate of a chemical substance used in each process managed by the minimum organization unit, and registers the data input from the user in the PRTR transfer rate information file 168 like the one shown in FIG. 4.

[Operation of Data Input Section]

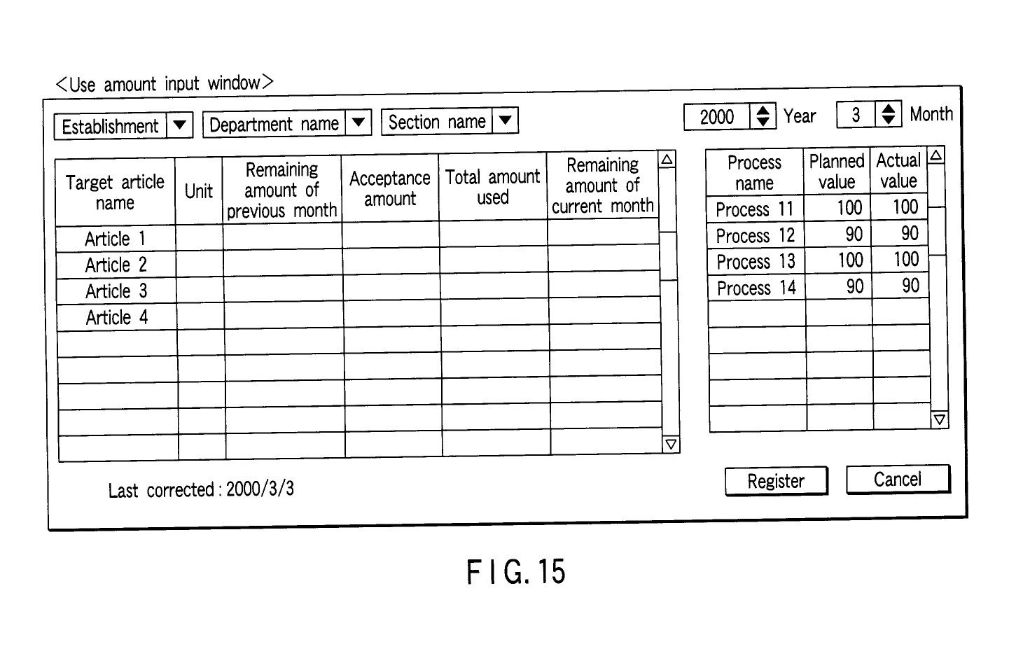

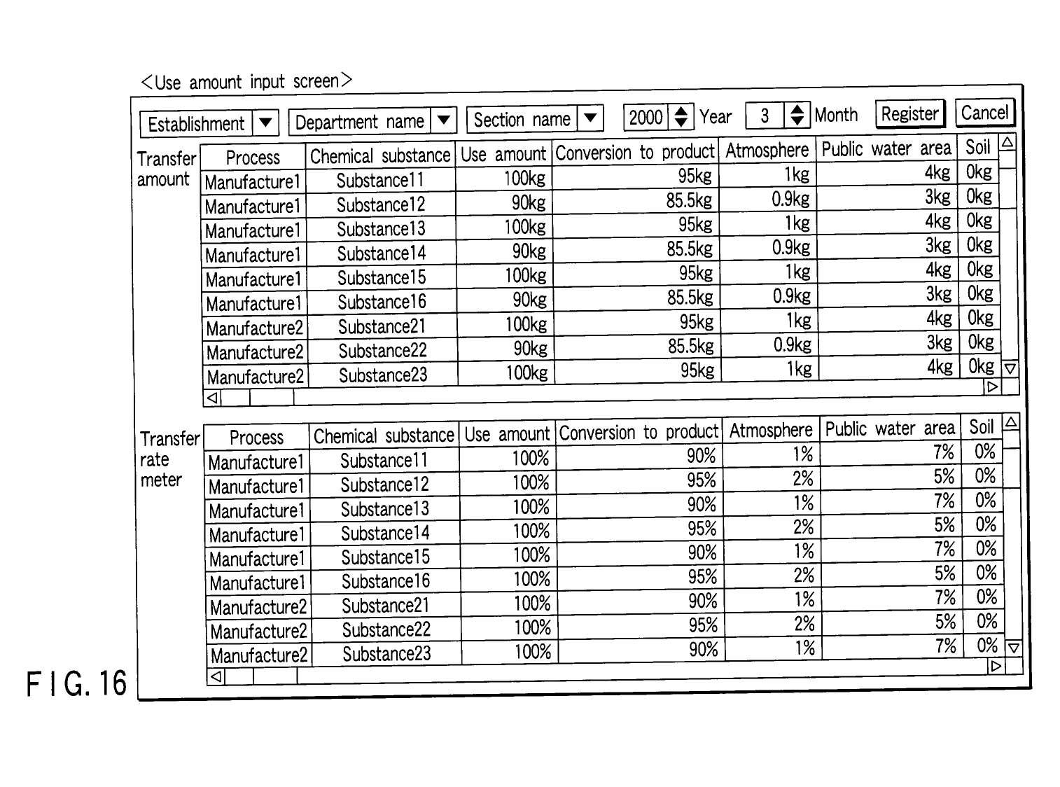

As described above, the data input section 130 is a section corresponding to the work done by persons in charge of storage, manufacture, processing, and transportation. As shown in FIGS. 15 and 16, therefore, the data input section 130 performs support display operation to make each person in charge input a use amount and PRTR transfer rate. When pieces of information are input or designated by the person in charge, the data input section 130 registers the pieces of information.

FIGS. 15 and 16 are views showing a window display for use amount input operation performed by the use amount input section 131 in the data input section 130, and a window display for PRTR transfer rate input operation performed by the PRTR transfer amount input section 132.

As shown in FIG. 15, the use amount input section 131 performs support operation to make the user to input at least an acceptance amount and use amount on a target article basis in each unit period of time, and registers the data input from the user in the target article use amount information file 169 like the one shown in FIG. 4.

As shown in FIG. 16, the PRTR transfer amount input section 132 performs support operation to make the user inputs at least the transfer amount of chemical substance used in each process within a unit period of time, and registers the data input from the user in the PRTR transfer amount information file 170 like the one shown in FIG. 4.

In this case, the PRTR transfer amount input section 132 causes the PRTR transfer amount calculation processing section 180 (FIG. 4) to calculate a PRTR transfer amount on the basis of the PRTR transfer rate set by the PRTR transfer rate setting section 123, and displays the obtained values as a default value of PRTR transfer amount on the window. If this default value is corrected by the user, the PRTR transfer amount input section 132 registers the corrected value as an actual PRTR transfer amount. If the default value is approved by the user, the PRTR transfer amount input section 132 registers the default value without any change.

The PRTR transfer amount input section 132 also displays the PRTR transfer rate set by the PRTR transfer rate setting section 123 as a default value to allow the user to correct it. If one of the PRTR transfer amount and PRTR transfer rate displayed is corrected, the other value is automatically corrected by recalculation based on the corrected value. As a consequence, both the PRTR transfer amount information file 170 and the PRTR transfer rate information file 168 like those shown in FIG. 4 are updated. Every time the PRTR transfer amount information file 170 and PRTR transfer rate information file 168 are updated, the corresponding log information is accumulated in the log file 171.

[Operation of Summation result Output Section]

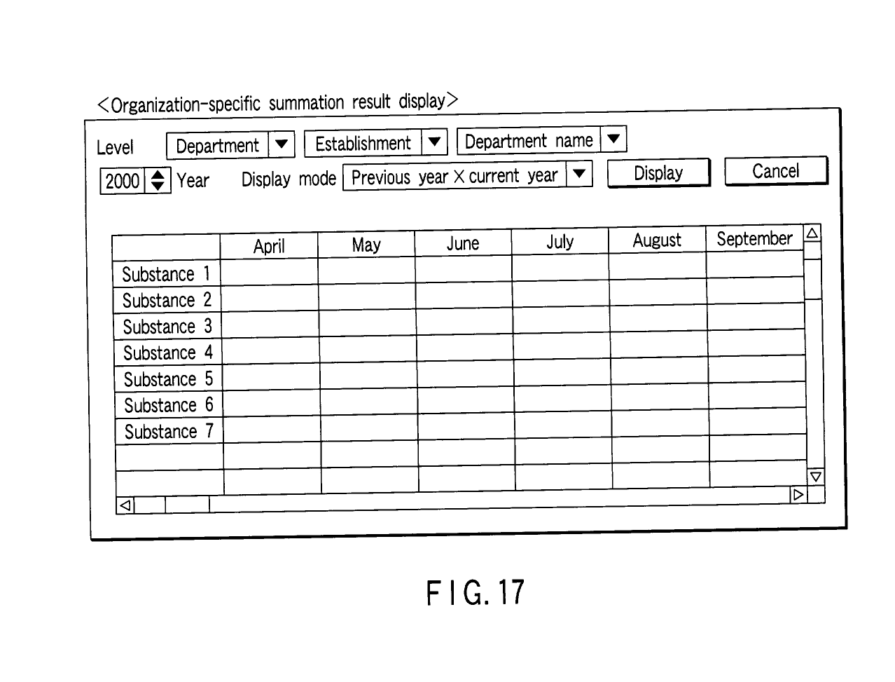

As described above, the summation result output section 140 is a section corresponding to the management work done by a facility or establishment manager. The summation result output section 140 therefore performs support display operation to display, to such a manager, choices like an organization-specific summation result display, monthly summation result display, chemical-substance-specific summation result display, and PRTR summation result display, totalizes the pieces of information obtained by the first basic information registration sections 110 and 120 or data input section 130 in accordance with the selected display type, and displays the corresponding summation result display window, as shown in one of FIGS. 17 to 20.

FIG. 17 is a view showing a window display for organization-specific summation result display operation performed by the organization-specific summation result display section 141 in the summation result output section 140. As shown in FIG. 17, the organization-specific summation result display section 141 displays selection windows for the organization levels and years registered by the first basic information registration section 110, and displays monthly summation results for the respective chemical substances at the organization level and in the year which are selected by the user in the respective selection windows.

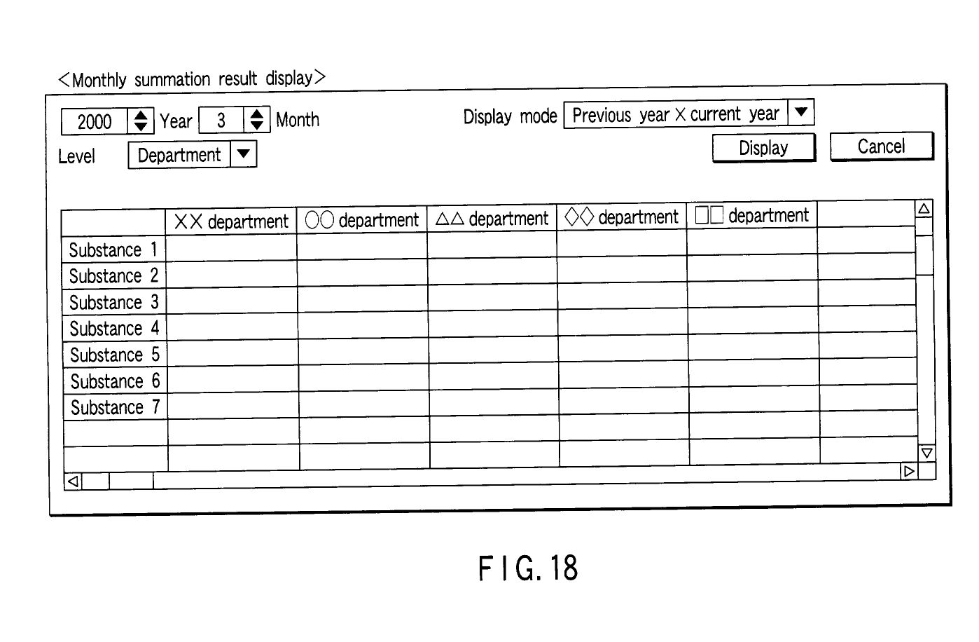

FIG. 18 is a view showing a window display for monthly summation result display operation performed by the monthly summation result display section 142 in the summation result output section 140. As shown in FIG. 18, the monthly summation result display section 142 displays selection windows for the organization levels and years/months registered by the first basic information registration section 110, and displays the organization-specific summation results for the respective chemical substances in the year/month and at the organization level which are selected by the user in the respective selection windows.

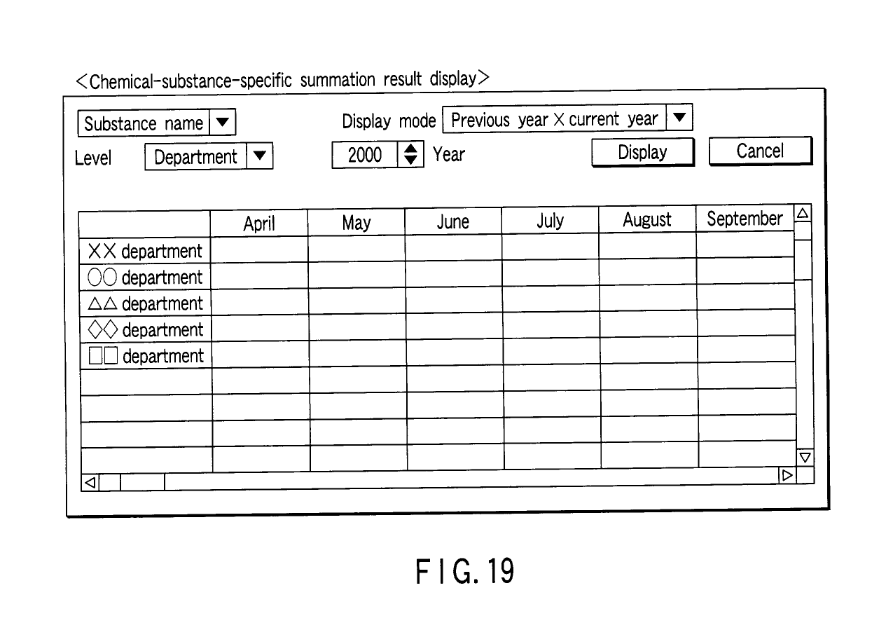

FIG. 19 is a view showing a window display for chemical-substance-specific summation result display operation performed by the chemical-specific summation result display section 143 in the summation result output section 140. As shown in FIG. 19, the chemical-specific summation result display section 143 displays selection windows for the organization levels, chemical substances, and years registered by the first basic information registration section 110, and displays monthly summation results for the selected chemical substance at the organization level and in the year which are selected by the user in the respective selection windows.

As shown in FIGS. 17 to 19, in the organization-specific summation result display section 141, monthly summation result display section 142, and chemical-specific summation result display section 143, “use amount”, “use amounts in previous and current years”, “planned and actual use amounts”, “acceptance amount, use amount, and remaining amount”, and the like may be set in advance as display modes to allow the user to select them in selection windows.

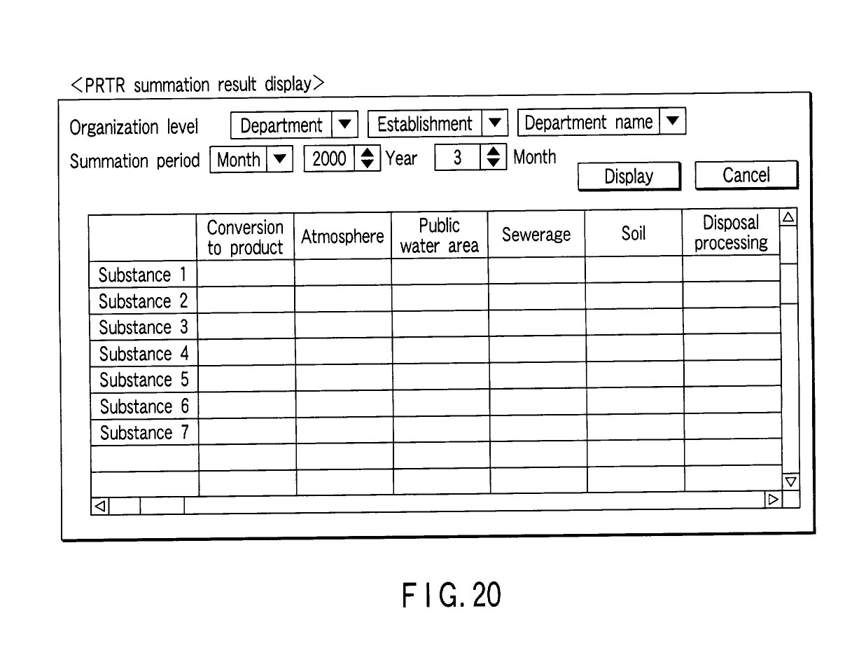

FIG. 20 is a view showing a window display for PRTR summation result display operation performed by the PRTR summation result display section 144 in the summation result output section 140. As shown in FIG. 20, the PRTR summation result display section 144 displays selection windows for the organization levels and years/months registered by the first basic information registration section 110, and displays summation results on a transfer type basis for the respective chemical substances at the organization level and in the year which are selected by the user in the respective selection windows.

[Operation of Report Output Section]

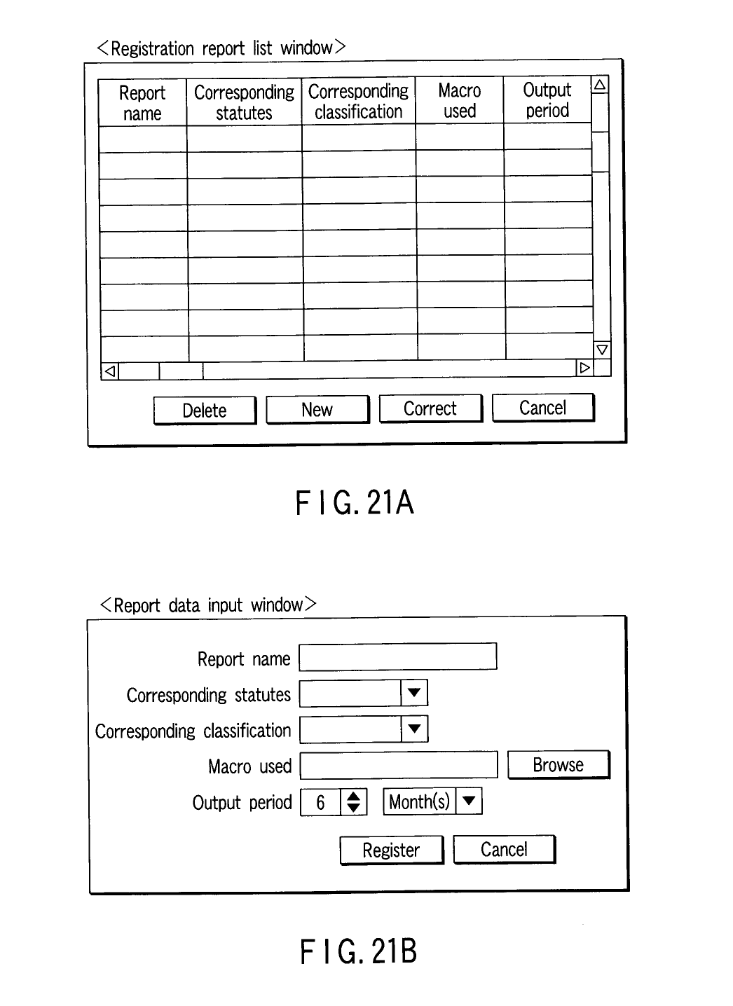

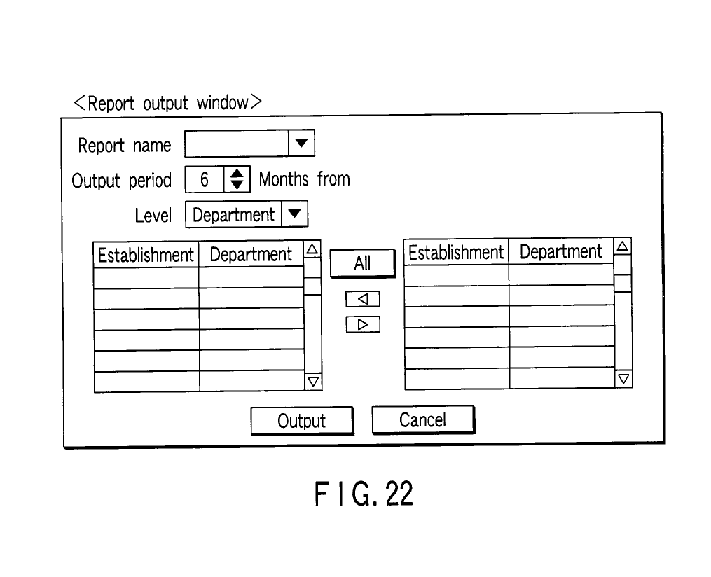

As described above, the report setting/outputting section 150 is a section corresponding to report creation work for reports directed to government and municipal offices and voluntary management. The report setting/outputting section 150 therefore performs support display operation for report setting operation like that shown in FIGS. 21A and 21B to allow a person in charge of such work to make format settings for a report, and also performs support display operation for the selection of a report. In accordance with the selected report, the report setting/outputting section 150 displays or prints out a report window, as shown in FIG. 22.

FIGS. 21A and 21B are views showing window displays for report setting operation performed by the report setting section 151 in the report setting/outputting section 150. As shown in FIG. 21B, the report setting section 151 displays selection windows for the statutes and classifications registered by the first basic information registration section 110, and registers the statute and classification selected by the user in the respective selection windows, the report name input or designated by the user, and the like as report setting data.

FIG. 22 is a view showing a window display for report output operation performed by the report output section 152 in the report setting/outputting section 150. As shown in FIG. 22, the report output section 152 displays selection windows for the reports, output periods, organization levels set by the report setting section 151, creates the report selected by the user on the basis of the corresponding selection window display in accordance with the selected output period and organization level, and displays the resultant data as a report on the screen or prints it out.

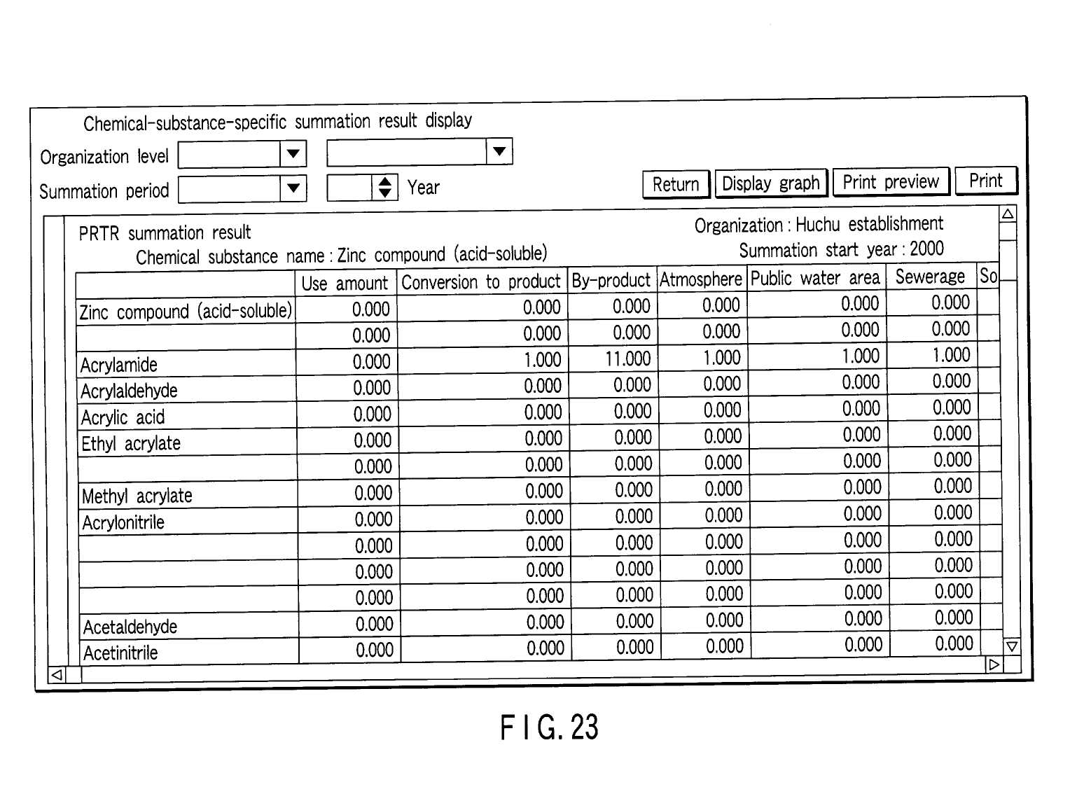

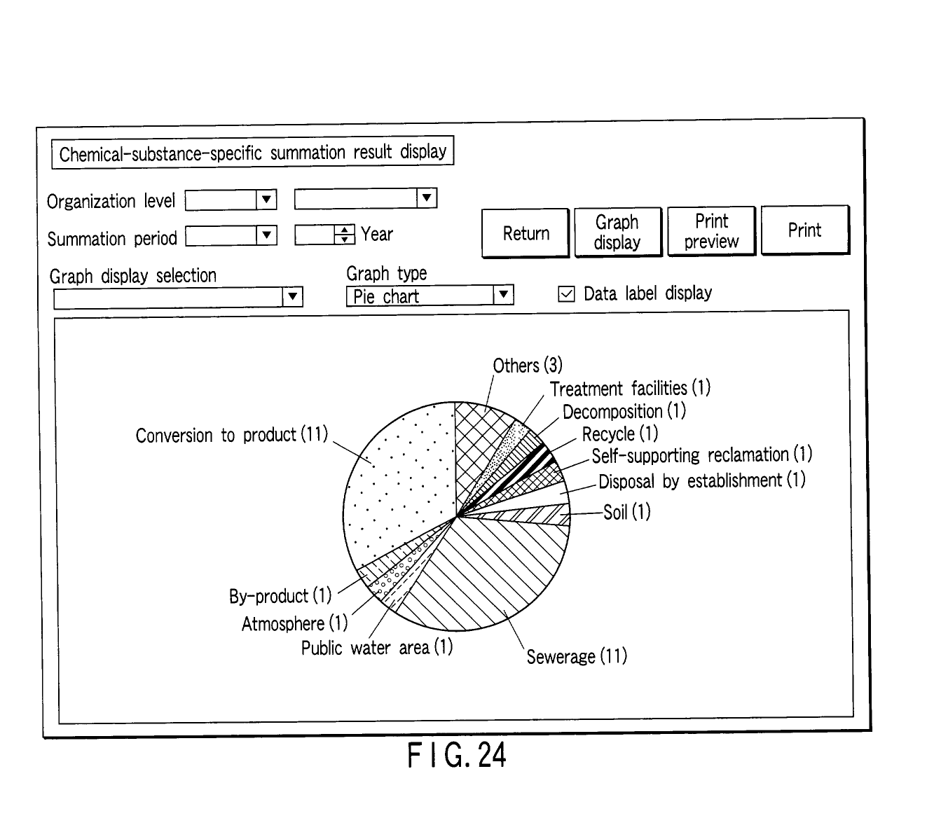

In addition, as shown in FIG. 23, the report output section 152 may output reports similar to the contents displayed by the respective summation result display sections 141 to 144 of the summation result output section 140. FIG. 23 is a view showing a window display for PRTR summation result display operation performed by the report output section 152. If a PRTR summation result display is selected as a report by the user, the report output section 152 displays selection widows for the organization levels and summation periods registered by the first basic information registration section 110, and displays summation results on a transfer type basis for the respective chemical substances at the organization level and in the summation period which are selected by the user in the respective selection windows. On such a report window display, a display window switching button, print execution button, and the like may be displayed. FIG. 24 is a view showing a window display in a case where part of the PRTR summation result display contents is displayed in graphical form.

Each section (means) described in the above description can be written in a recording medium such as a magnetic disk, optical disk, or semiconductor memory as a program that can be executed by a computer and applied to various types of apparatuses. Alternatively, such a program can be transmitted over a communication medium and applied to various types of apparatuses. A computer that implements central processing reads out the program recorded on a recording medium, and its operation is controlled by the program, thereby executing the above processing.

[Functions/Effects of First Embodiment]

The followings are the functions/effects of this embodiment having the above arrangement.

[Facilitation of Work Owing to Function Division]

First of all, since the function for environmental management is divided in accordance with the respective types of work, the tasks of each work associated with environmental management can be simplified.

More specifically, this system is roughly divided into the basic information management section 101 (first basic information registration sections 110 and 120) serving as a functional section corresponding to the work to be done by environmental management staff having an expert knowledge about environmental management or a person in charge of environmental management, the input data management section 102 (data input section 130) serving as a functional section corresponding to the work to be done by a field worker in charge of manufacture, processing, storage, or transportation, who has no expert knowledge about environmental management, and the summation result management section 103 (summation result output section 140 and report setting/outputting section 150) serving as a functional section corresponding to the analytical work for recording, reporting, and improvement, which is to be done by an establishment manager.

The environmental management expert staff can therefore construct a database for management, in which chemical substances are brought into correspondence with statutes, by only registering a plurality of types of basic information. This greatly reduces the construction task load as compared with a case where a complicated database designed to correspond to report outputs is constructed in advance.

In addition, since the field worker in charge of manufacture, processing, storage, or transportation is only required to input variables such as a use amount and storage amount, even the field worker in charge who has no expert knowledge about environmental management can make input settings with relative ease.

Furthermore, the establishment information registration section 111, associated statute registration section 112, chemical substance registration section 113, target article registration section 115, and the like are separately provided for the first basic information registration section 110, and these selections can independently store information. Even if, therefore, some information is not clear, only clear information can be separately registered. This makes it possible to simplify each registration task and facilitate task sharing.

The simple mobile terminal apparatus 5, in particular, exhibits good operability at the site because of radio communication, but the transmission rate is lower than that in wire communication. For this reason, when the amount of data to be transmitted is reduced by function division as in the system of this embodiment, the response performance can be improved, and the time required for tasks at the site can be shortened.

[Construction of Database Effective for Compliance with Statutes/Laws and Regulation]

In this system, since a database in which chemical substances are brought into correspondence with statutes can be easily constructed, management can be performed in compliance with statutes/laws and regulations on the basis of the database. That is, even without any expert knowledge about the statutes/laws and regulations associated with chemical substance management, PRTR target substance management and drainage management can be done in compliance with these statutes/laws and regulations. In this case, statutes/laws and regulations and chemical substances can be easily associated by a method of selecting chemical substance names from a chemical substance database and inputting them. More specifically, the maximum and minimum values stipulated by statutes/laws and regulations and management values that are voluntarily managed can be easily managed by registering such values as basic information in advance.

Since the chemical substance registration section 113 of the first basic information registration section 110 sets the information of chemical substances and statutes/laws and regulations in correspondence with target articles set on a process basis, statutes/laws and regulations can be easily brought into correspondence with chemical substances in management of chemical substances at a process level.

In addition, since the chemical substance registration section 113 registers contents in a compound and associated statutes concerning not only PRTR target substances but also PRTR target substance contained in the compound, the transfer amounts of PRTR target substances in the compound can be easily obtained. This allows management in compliance with laws.

As described above, a database for bringing chemical substances into correspondence with statutes can be set in the form of registration of basic information on the user side, as needed. With the construction of such an open database, it suffices if the user holds only necessary minimum chemical substance data and statute data; the user need not have an enormous data file storing overall chemical substances. In addition, even if the establishments of the user exist in a plurality of countries, since a file unique to the user can be defined, voluntary management can be performed in compliance with statutes/laws and regulations in the respective countries. Furthermore, the database in this system is simple, and hence a search function based on a general, basic technique will suffice; no special search function is required.

[Management of PRTR Transfer Amount at Each Organization Level and in Each Process]

As described above, the acceptance amount, use amount, disposal amount, and the like of a chemical substance can be managed by an organization such as a section or department that handles the chemical substance. With regard to PRTR transfer amounts, however, since the transfer rates of chemical substances to the environment, e.g., the air, public water areas, drainage, and soil, vary depending on the characteristics of manufacturing facilities and apparatuses used in organizations, management needs to be performed in accordance with these variations. In contrast to this, in this system, an organization is hierarchically divided to allow management of PRTR transfer amounts in each process. Such management on a process basis can be realized because the transfer amount data of all chemical substances included in the respective processes can be formed into a database. This point will be described below.

First of all, the target article registration section 115 of the first basic information registration section 110 registers the contents of chemical substances in a target article. The use amount input section 131 of the data input section 130 then inputs the use amounts of chemical substances for each target article containing the chemical substances and each process. This makes it possible to collectively manage the amounts of chemical substances used in the respective processes. In addition, the PRTR transfer rate setting section 123 of the second basic information registration section 120 displays a list of processes including chemical substances and the chemical substances registered in the respective processes, and sets a PRTR transfer rate for each chemical substance, thereby comprehensively managing transfer amounts in the respective processes in accordance with chemical substances and the respective transfer types.

In addition, the transfer amounts of chemical substances can be comprehensively managed on a transfer type basis in each process on the basis of the set PRTR transfer rates. By registering chemical substance information in each process on an organization basis, in particular, by using the to-be-used target article setting section 121, use amount plan setting section 122, and PRTR transfer rate setting section 123 of the second basic information registration section 120, PRTR transfer amounts can be precisely grasped and managed on an establishment basis, section basis, department basis, and process basis.

The PRTR transfer amount input section 132 of the data input section 130 displays the PRTR transfer amount, as a default value, calculated on the basis of the PRTR transfer rate set by the PRTR transfer rate setting section 123 and the use amount input by the use amount input section 131, and also displays the PRTR transfer rate itself as a default values. It therefore suffices if the user corrects one of the values only when an actual value differs from the corresponding default value. That is, when the user corrects one of the PRTR transfer rate and the PRTR transfer rate, the other value is automatically corrected.

In this system, therefore, the user is only required to input the use amount of chemical substance in each process. In addition, since PRTR transfer amounts are automatically totalized on the basis of input use amount data to display a default value, it suffices if a correction is made only when the value differs from an actual value. This facilitates input operation for PRTR transfer amounts. With regard to PRTR transfer amount input operation, both a transfer amount and a transfer rate can be easily managed by an operation manager, and data can be updated on the basis of actual values. In addition, since matching between the values of PRTR transfer amounts and PRTR transfer rates is automatically maintained properly all the time, the reliability of data can be improved.

Note that transfer amounts and transfer rates are generally corrected on the basis of actual measurements. The accuracy and reliability of management can therefore be improved by discriminating (identifying) corrected/input values from default values by displaying them in different colors or the like or storing a correction log with comments.

Since actual measurement of transfer rates cannot be frequently done in consideration of facilities and cost, in particular, discrimination of estimated values from measurement values produces a great effect.

[Utility of Summation Result Display]

In this system, the data obtained by the first basic information registration sections 110 and 120 and data input section 130 can be properly totalized and displayed as a PRTR summation result by using the summation result output section 140 under the condition required by the user, e.g., on an organization basis, yearly/monthly basis, a chemical substance basis, or a composition basis. According to the report setting/outputting section 150, in particular, the user can easily set a report conforming to the format of a report directed to government and municipal offices or a report for voluntary management, and the summation result of the transfer amounts of chemical substance can be freely displayed. Furthermore, as shown in FIGS. 23 and 24, since a plurality of types of display forms, e.g., table and graph display forms, can be switched, a summation result can be grasped more easily, and the usefulness of data can be improved.

[Merits in User Certificate for Each Functional Section]

This system is a client-server system, and is designed to input a user certificate every time each of the basic information management section 101, input data management section 102, and summation result management section 103 is activated. This allows each person in charge to activate only a necessary functional section by inputting a user certificate in each of different types of work, thus preventing the user from activating any unnecessary functional section. By decentralizing the function of environmental management and making the user input a user certificate for each function section, an improvement in security is achieved to protect a constructed database. This provides excellent reliability.

[Facilitation of Management by Standardization of Units]

In this system, management is facilitated by standardizing the units of chemical substances. More specifically, when the target article registration section 115 handles target article registration information in consideration of specific gravity, the units of the use amounts of all chemical substance can be standardized to facilitate management. In addition, in obtaining the use amounts and use ratios of chemical substances, the contents of chemical substances used can be easily calculated on the basis of the registered unit and specific gravity of a target article. The use amounts of all chemical substances can be calculated in the unit standardized by using contents.

[Modification of First Embodiment]

Note that in using the system configuration according to the first embodiment, only the operation procedure can be changed. A plurality of operation procedures will be sequentially described below.

[Distributed Data Procedure by Function Selection]

As described above, this system is roughly divided into the basic information management section 101 (first and second basic information registration sections 110 and 120) serving as a functional section corresponding to the work to be done by environmental management staff having an expert knowledge about environmental management or a person in charge of environmental management, the input data management section 102 (data input section 130) serving as a functional section corresponding to the work to be done by a field worker in charge of manufacture, processing, storage, or transportation, who has no expert knowledge about environmental management, and the summation result management section 103 (summation result output section 140 and report setting/outputting section 150) serving as a functional section corresponding to the analytical work for recording, reporting, and improvement, which is to be done by an establishment manager. In practice, therefore, since different departments take charge of inputting or outputting information at different functional sections, distributed data processing is performed by operating only a functional section corresponding to the work of which each department is in charge.

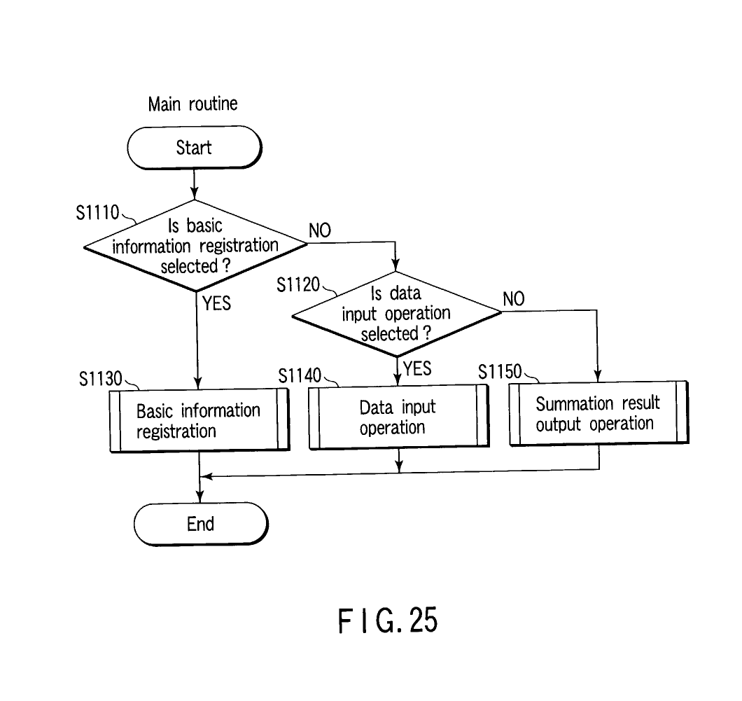

FIG. 25 is a flow chart showing a specific main routine for the above distributed data processing. As shown in FIG. 25, in accordance with selection of “basic information registration”, “data input”, or “summation result output” (steps S1110 and S1120), data input processing (step S1130) by the basic information management section 101, data input processing (step S1140) by the input data management section 102, or summation result output processing (step S1150) by the summation result management section 103 is performed.

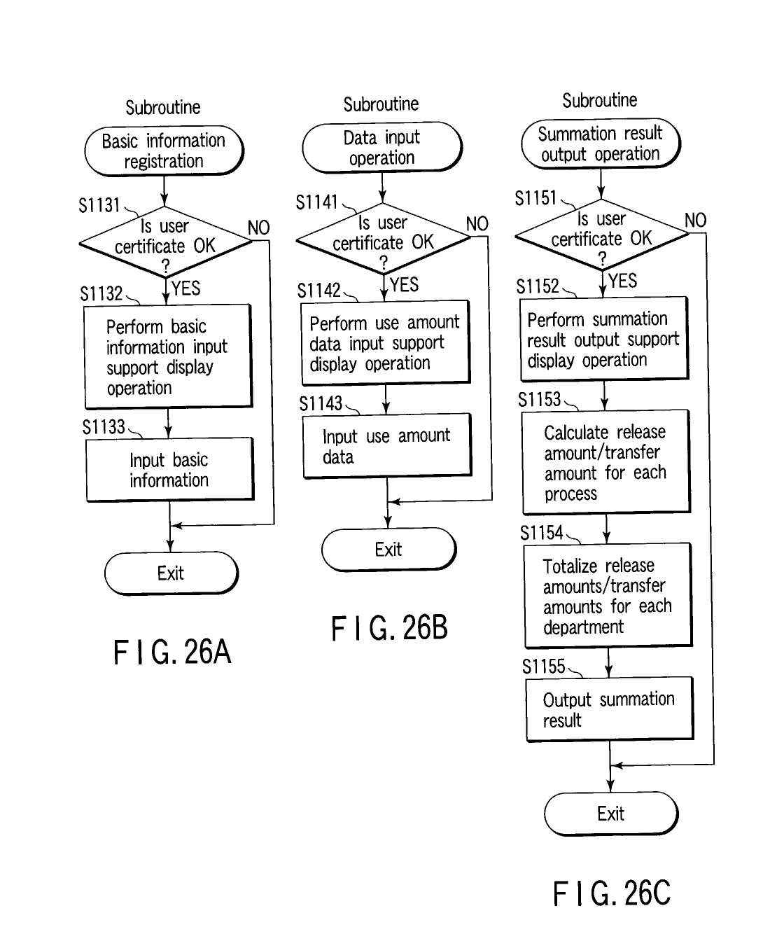

FIGS. 26A to 26C are flow charts showing subroutines for the three processes shown in FIG. 25.

FIG. 26A shows a subroutine for basic information registration processing (step S1130). If it is determined that a user certificate is input (YES in step S1131), input support display operation for basic information is performed (step S1132) to input the basic information acquired from the fuser (step S1133).

FIG. 26B shows a subroutine for data input processing (step S1140). If it is determined that a user certificate is input (YES in step S1141), input support display operation for use amount data is performed (step S1142) to input the use amount data acquired from the user (step S1143).

FIG. 26C shows a subroutine for summation result output processing (step S1150). If it is determined that a user certificate is input (YES in step S1151), output support display operation for a summation result is performed (step S152). Release amounts/transfer amounts are calculated for the respective processes in accordance with the output condition acquired from the user (step S1153). The release amounts/transfer amounts are then totalized on a department basis (step S1154), and the summation results are output (step S1155).

Note that the processing in step S1153 may be performed after the use amount data input processing (step S1143) in FIG. 26B.

According to this procedure, while processing for environmental management is distributed in accordance with the work to be done, a user certificate is input for each functional section, i.e., each of the basic information management section 101, input data management section 102, and summation result management section 103 to attain an improvement in security so as to protect the constructed database. This procedure is therefore excellent in reliability. In this case, if different user certificates are set for different functional sections, there is no chance that data is erroneously changed in a wrong department. A constructed database may be designed to allow search/display even without any user certificate input. This allows the database to be used more widely.

[Distributed Data Procedure with High Priority on Use Amount Data Input]

In this system, in normal operation, input processing for use amount data is performed substantially most frequently as compared with basic information registration processing and summation result output processing. When the system is started, the input data management section 102 may be activated first to improve operation efficiency.

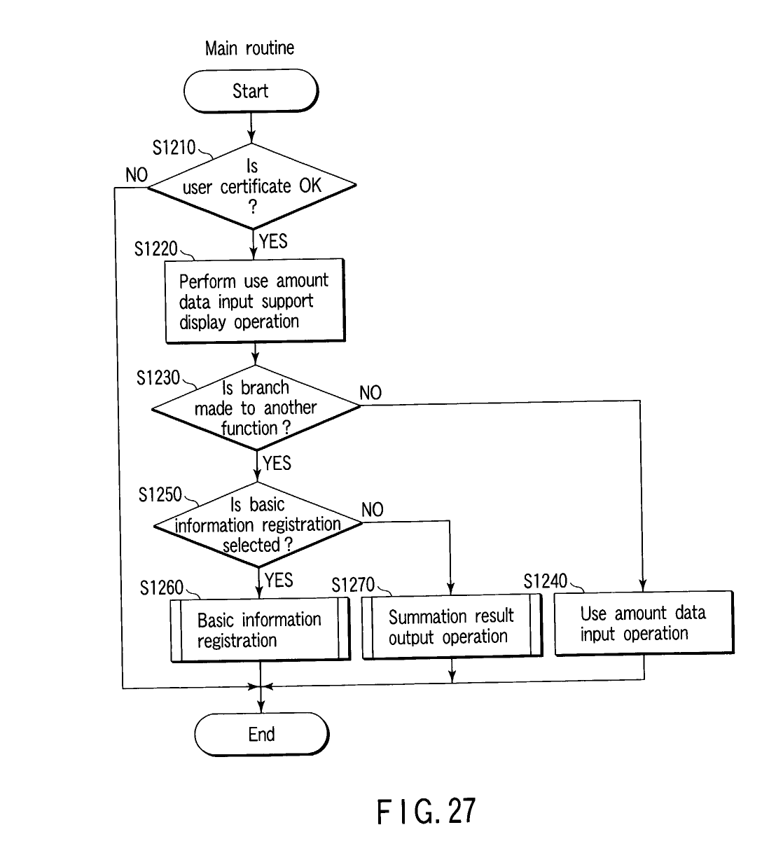

FIG. 27 is a flow chart showing a main routine for a case where the input data management section 102 is activated first to immediately start use amount data input processing. As shown in FIG. 27, if it is determined that a user certificate is input (YES in step S1210), the input data management section 102 is immediately activated to perform input support display operation for use amount data (step S1220). If there is no instruction to branch to another function (NO in step S1230), use amount data input operation is performed (step S1240).

If there is an instruction to branch to another function (YES in step S1230), and “basic information input” or “summation result output” is selected (step S1250), basic information registration processing (step S1260) by the basic information management section 101 or summation result output processing (step S1270) by the summation result management section 103 is performed in accordance with the selected function.

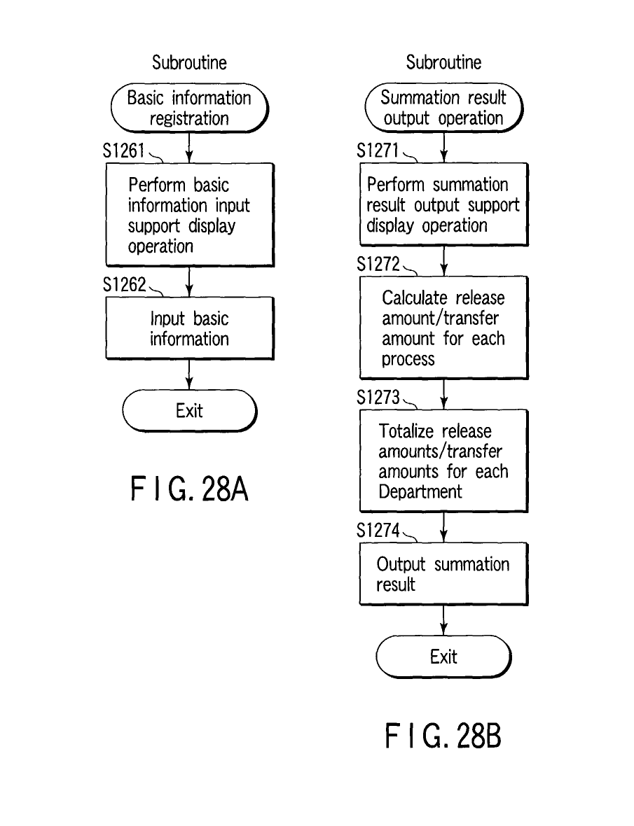

FIGS. 28A and 28B are flow charts showing subroutines for the two processes shown in FIG. 27.

FIG. 28A shows a subroutine for basic information registration processing (step S1260). Input support display operation for basic information is performed (step S1261), and the basic information acquired from the user is input (step S1262).

FIG. 28B shows a subroutine for summation result output processing (step S1270). Output support display operation for summation results is performed (step S1271), and the release amounts/transfer amounts are calculated on a process basis in accordance with the output condition acquired from the user (step S1272) and totalized on a department basis (step S1273). The resultant summation results are then output (step S1274).

Note that the processing in step S1272 may be performed after the use amount data input processing (step S1240) in FIG. 27.

According to this procedure, when the system is started in normal operation after a predetermined amount or more of basic information is registered and a basic information database is constructed to the extent that at least use amount data input processing can be performed, the input data management section 102 is activated first to allow the user to immediately perform use amount data input operation. As compared with the procedure shown in FIG. 25, therefore, windows for function selection need not be switched, and use amount data input operation can be started quickly accordingly. In this manner, by giving high priority to use amount data input processing that is expected to be performed most frequently, the operation efficiency can be improved.

[Procedure for Receiving External Data]

In this system, external data are received in different manners depending on who performs input operation at each functional section. When the user is to execute a program by himself/herself, he/she downloads information about statutes and information about target articles from a site or company holding a database associated with statutes and target articles, or acquires such information by accessing a medium such as a CD-ROM. These pieces of information need to always be updated to newest information, it is preferable that the user can access external data as well as inputting information by himself/herself. It is also preferable that the user can acquire use amount/storage amount data by accessing an external inventory file, production file, and the like.

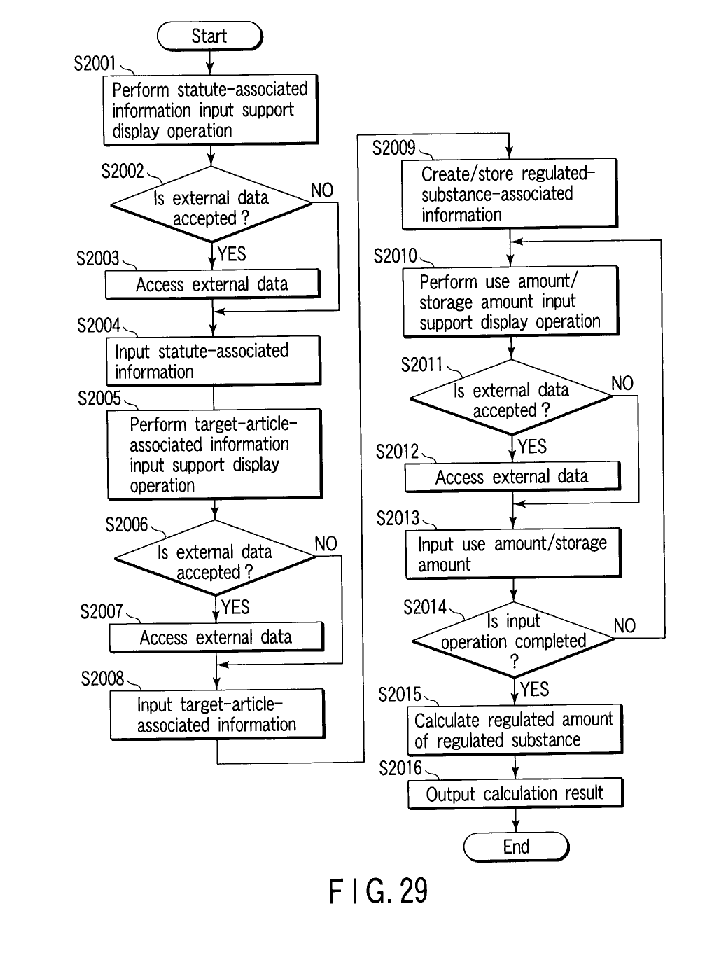

FIG. 29 is a flow chart showing a procedure for receiving external data in the above manner. As shown in FIG. 29, first of all, input support display operation for statute-associated information is performed (step S2001). If reception of external data is required (YES in step S2002), access is made to external data (step S2003) to acquire and input statute-associated information (step S2004). If reception of external data is not required as in a case where the user is holding statute-associated information (NO in step S2002), the statute-associated information is acquired from the user and input (step S2004).

Subsequently, input support display for target-article-associated information (step S2005). If reception of external data is required (YES in step S2006), access is made to external data (step S2007) to acquire and input target-article-associated information (step S2008). If reception of external data is not required as in a case where the user is holding target-article-associated information (NO in step S2006), target-article-associated information is acquired from the user and input (step S2008). Regulated-substance-related information is then created and stored on the basis of the acquired target-article-associated information (step S2009).

Input support display operation for use amount/storage amount data is performed (step S2010). If reception of external data is required (YES in step S2011), access is made to external data (step S2012) to acquire and input use amount/storage amount data (step S2013). If reception of external data is not required as in a case where the user is holding use amount/storage amount data (NO in step S2011), use amount/storage amount data is acquired from the user and input (step S2013). When steps S2010 to S2013 are repeated until necessary use amount/storage amount data are completely input, and it is determined that use amount/storage amount data are completely input (YES in step S2014), the regulated amount of regulated substance is calculated (step S2015), and the calculation result is output (step S2016).

According to this procedure, since external data can be used as both basic information and use amount/storage amount data, even if the user has no data, he/she can efficiently acquire calculation results on the regulated amounts of regulated substances by accessing external data as needed. This makes it possible to greatly simplify the system and provide an excellent economical advantage.

The user of a program may provide summation results for the third person as a client. More specifically, the data held by the third person as a client may be used as statute-associated information, target-article-associated information, and use amount/storage amount data, instead of the data held by the program user. In this case, the external data shown in FIG. 29 becomes the data held by the third person as a client, and the program user can input various data held by himself/herself in the respective steps, in addition to the external data.

The calculation results are therefore provided for the third person as a client in the form of storing the data in a storage medium such as a CD-R, CD-ROM, or MO, in addition to the output from described above, or transmitted to the third person through a network, as well as being output to an output unit, such as the printer, file, or display of the user.

[Distributed Data Procedure Using External Data]

In the procedure shown in FIG. 29, external data are used as both basic information and use amount/storage amount data. In reality, however, in many cases, input operation is performed by using external data for only statute-associated information and target-article-associated information which tend to be most expert and complicated information, while using the data held by the user for information associated with the user, e.g., a company name. In addition, in many cases, use amount/storage amount data is input by a field worker in charge of the corresponding work, and summation results are output by a company manager or the like who takes charge of analysis/reporting work.

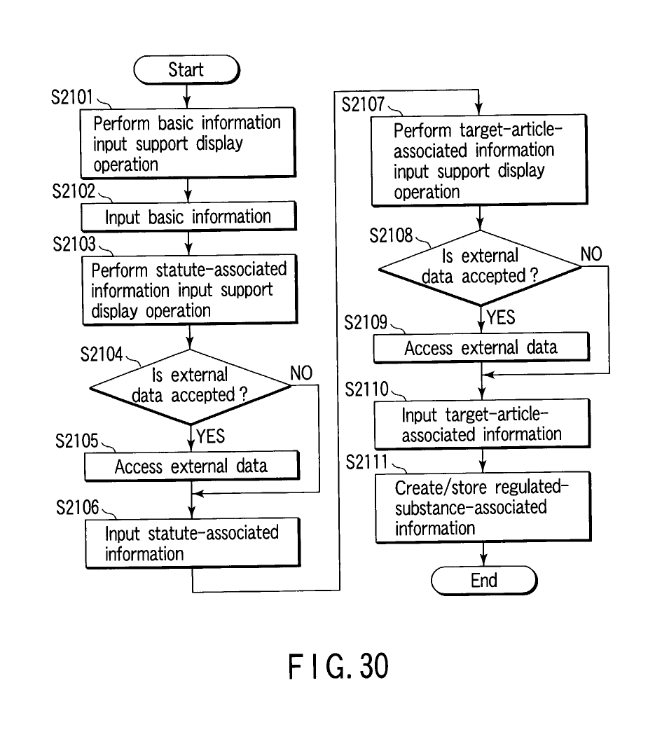

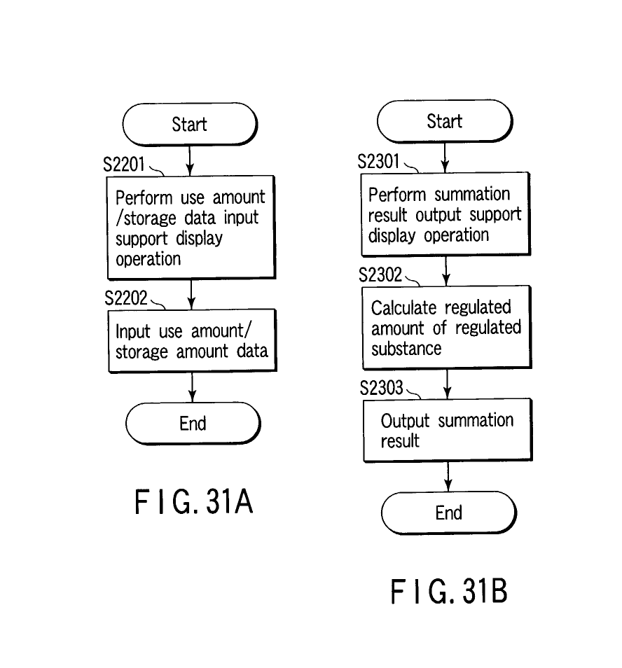

FIGS. 30 to 31B are flow charts showing procedures for performing distributed data processing by using external data for only part of basic information. FIG. 30 shows a procedure for basic information registration. FIGS. 31A and 31B show procedures for data input operation and summation result output operation.

As shown in FIG. 30, in registering basic information, first of all, input support display operation for basic information associated with the user, e.g., establishment information, is performed (step S2101) to acquire the data held by the user and input it as basic information (step S2102). Input support display operation for statute-associated information is then performed (step S2103). If reception of external data is required (YES in step S2104), the external data is accessed (step S2105) to acquire and input statute-associated information (step S2106). If reception of external data is not required as in a case where statute-associated information is held by the user (NO in step S2104), the statute-associated information is acquired from the user and input (step S2106).

Subsequently, input support display operation for target-article-associated information is performed (step S2107). If reception of external data is required (YES in step S2108), external data is accessed (step S2109) to acquire and input target-article-associated information (step S2110). If reception of external data is not required as in a case where target-article-associated information is held by the user (NO in step S2109), the target-article-associated information is acquired from the user and input (step S2110). Regulated-substance-associated information is then created/stored on the basis of the acquired target-article-associated information (step S2111).

As shown in FIG. 31A, in inputting use amount/storage amount data, input support display operation for use amount/storage amount data is performed (step S2201) to acquire and input use amount/storage amount data from the user (step S2202).

As shown in FIG. 31B, in outputting summation results, output support display operation of summation results is performed (step S2301). The regulated amounts of regulated substances are calculated (step S2302) and the summation results are output (step S2303) in accordance with the output condition acquired from the user.

Note that the processing in step S2302 may be performed after the use amount/storage amount data input processing (step S2202) in FIG. 31A.

According to this procedure, the user can use external data for only data that tend to be most expert and complicated, e.g., statute-associated information and target-article-associated information, and can use the data held by himself/herself for information associated with the user, e.g., a company name. The user can therefore efficiently input basic information by selectively using the data held by himself/herself and external data. When the user accesses external data for the data held by himself/herself, it takes a longer time than when the data held by himself/herself is directly input. For this reason, the above selective use of data can reliably contribute to an improvement in operation efficiency. In addition, in this procedure, since three types of processes, namely “basic information registration”, “data input”, and “summation result output”, are performed completely independently of each other, each processing can be immediately started in corresponding work without any function selection, thus attaining an improvement in operation efficiency.

The above description is based on the client-server type system configuration. If, however, the functions of the respective sections (means) described above are compiled in the server of an Internet provider, a plurality of users can use the function of the system according to this embodiment through terminals. Obviously, such a system can be used as a stand-alone system.

[Second Embodiment]

The second embodiment of the present invention will be described next.

In the second embodiment, a program for implementing the environmental management system described in the first embodiment is distributed to users to allow wider use of the system and allow the distributor to collect charges for program distribution from the users. In addition, this embodiment is designed to distribute consultation information required by users in association with a method of using the program, the summation results obtained by executing the program, and the like, as well as distributing the environmental management system.

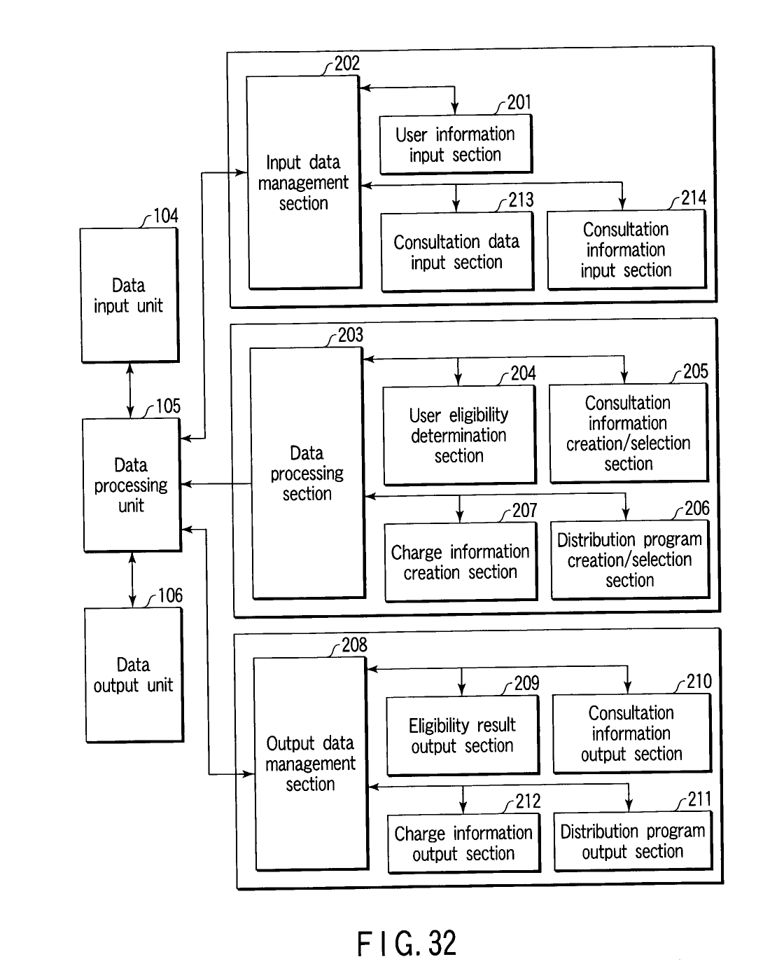

In the second embodiment, as shown in FIG. 32, a server which is a frame distributor includes a data input unit, data output unit, and data processing unit as hardware units, and an input data management section 202, data processing section 203, and output data management section 208 which are formed as software programs executed on the data processing unit.

The input data management section 202 includes a user information input section 201 which receives a distributed program. The user information input section 201 receives predetermined data from a data input unit such as a keyboard or mouse. The input data may include, for example, data transmitted from a data input unit on another server or terminal which accesses a Web page and the like developed on the distributor server and data supplied to the program distributor over a recording medium, in addition as data directly input from a data input unit provided for the server as the program distributor.

As the contents of data input to the user information input section 201, the following data are properly selected: the name, or, address or location of the user, destination address, the scale (the number of employees and production) of an establishment as a program management target, business category, target articles, necessity of consultation information, settlement method for charges for the distribution of the program and consultation information, settlement account, agreement concerning the distributed program, and the like.

This input data management section 202 includes a consultation data input section 213 for inputting data required for a consultation to the distributor server when a person who has received the program requests the provision of consultation information. This consultation data is used to perform various consultations about the results obtained by executing the distributed programs. If, for example, consultations are to be done concerning the transfer amounts/release amounts in each process, such consultation data are provided for them in each process.

The input data management section 202 includes a consultation information input section 214 for inputting the contents of a consultation. In this embodiment, consultation information suitable for a user can be automatically created or selected by a consultation information creation/selection section 205 to be described later. In addition, consultation information obtained by human decision can also be input in the form of a file or communication data.

The data processing section 203 for processing the data obtained by the consultation information input section 201 is provided for the distributor server. This data processing section 203 creates information required for distribution by controlling a user eligibility determination section 204, the consultation information creation/selection section 205, a distribution program creation/selection section 206, and a charge information creation section 207.

The user eligibility determination section 204 checks whether the user satisfies a condition for the reception of the program and consultation information. The user eligibility determination section 204 creates data to return the answer “there is no need to distribute the program” to the user upon determining from user information that an environmental management system like that of the present invention is not required as in an establishment that is equal to or smaller than a predetermined scale. The consultation information creation/selection section 205 creates consultation information in accordance with input user information or selects appropriate consultation information from pieces of consultation information prepared in advance.

If various versions of the distribution program are prepared in accordance with the scales and business objects of users, the distribution program creation/selection section 206 creates or selects a distribution program suitable for a user by selecting an appropriate version or attaching an option or add-in software to the program. Obviously, if only one type of distribution program is prepared, the prepared program is selected. The charge information creation section 207 creates information for charging in accordance with a predetermined charge system in association with the distribution of a distribution frame and consultation information which are created or selected. In this case, necessary information that needs to be notified to the user, e.g., information concerning when, how, and how much a charge should be demanded, and how settlement is made, are determined by referring to the contents of the input user information, distribution program, and consultation information.

An output data management section 208 is also provided for the distributor server to process the information about the eligibility of the user, consultation information, distribution program, and charge information, which are created or selected in the above manner, into output data conforming to the form of the data output unit. The output data management section 208 includes an eligibility result output section 209, consultation information output section 210, distribution program output section 211, and charge information output section 212. As the data output unit, a unit which writes data in a recording medium, e.g., a CD-R, CD-RW, MO, or DVD, mounted in the server itself, or a file in a user terminal connected through a communication network may be used. As described above, in accordance with a target data output unit, each of the output units 209 to 211 outputs the information created or selected to the data output unit upon properly selecting an output protocol or data format.

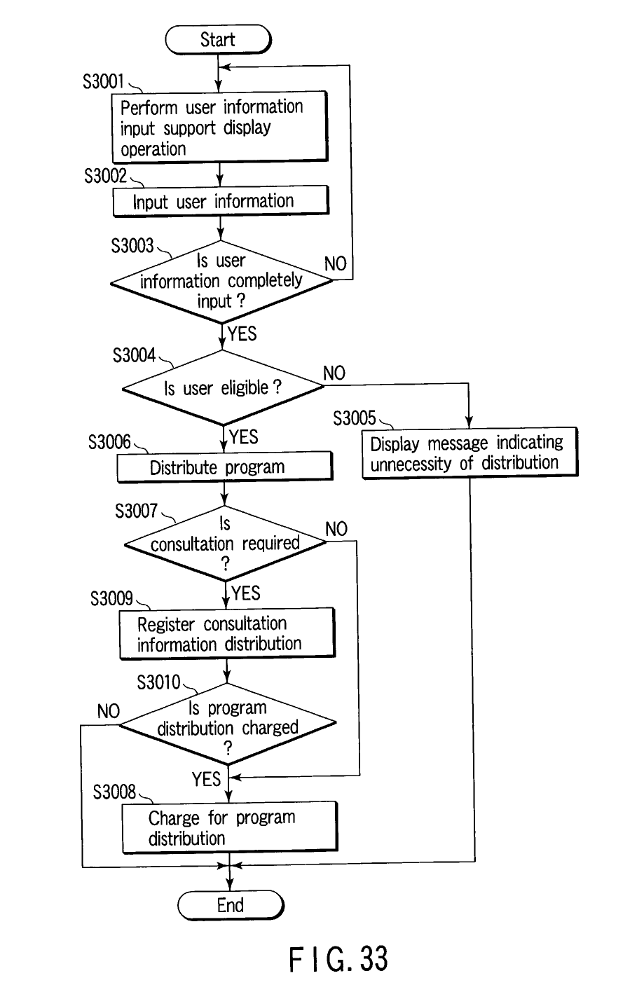

The operation of the second embodiment having this arrangement will be described with reference to the flow chart of FIG. 33.

A user who intends to receive a distribution program for an environmental management system from a distributor server accesses the distributor server through a network or another means to input necessary user information to the input data management section 202. In this case, the input data management section 202 displays an input window or menu to prompt the user to input user information (step S3001). The user inputs user information including the name, or address or location of the user, destination address, and the like, in addition to information indicating the necessity/unnecessity of a consultation, in accordance with the input menu (step S3002).

When user information is completely input (YES in step S3002), the user eligibility determination section 204 checks whether the program and consultation information are allowed to be distributed to the user. If the program cannot be distributed because the user is no eligible in receiving the program or the program and consultation information suitable for the user are not prepared in the distributor (NO in step S3004), the corresponding information is sent as a distribution disabled message from the eligibility result output section 209 to a data output unit such as a transmission unit, thereby displaying the distribution disabled message to the user (step S3005).

If it is determined that the user is eligible to receive the distribution of a program (YES in step S3004), the program creation/selection section 206 selects or creates a distribution program suitable for user information, and outputs this to a destination address on a communication network or a recording medium by using the function of the distribution program output section 211 and the data output unit (step S3006).

If user information contains input information indicating that no consultation information need be provided upon completion of the distribution of the program (NO in step S3007), a charge for the distribution of the program and user information required to demand the charge are created as charge information by the charge information creation section 207. This information is then stored in the distributor server and its contents are notified to the user through the charge information output section 212 and data output unit (step S3008).

Note that this charge information may be used to make immediate settlement through a user's bank account or credit card on the basis of the user information, as well as being simply notified to the user, and the contents of the transaction may be notified to the user. In addition, the charge information may be stored as accounts receivable in the charge information creation section 207, together with other charges of the user, and settlement may be made another day.

If it is determined that consultation information is required to be provided (YES in step S3007), the distribution of consultation information is registered, e.g., a flag indicating that the user requires the provision of consultation information is set (step S3009). The processing is then terminated to prepare for the provision of consultation information in the future. In this case, information required for the provision of consultation information, e.g., a date for the provision of consultation information, a method of providing information, and a charge, can also be registered. If this distribution is registered, a charge for the distribution of the program may be imposed as in the case where the provision of consultation information is not required (YES in step S3010). Alternatively, a charge for the distribution of the program may be collected when the program is provided (NO in step S3010).

The user who has received the distribution of the program in the above manner executes the program to acquire information associated with release amounts/transfer amounts on a process basis, release amounts/transfer amounts on a department basis, and regulated substances, and data associated with the regulated amounts of regulated substances and the like as described in the first embodiment, and uses them for environmental management.

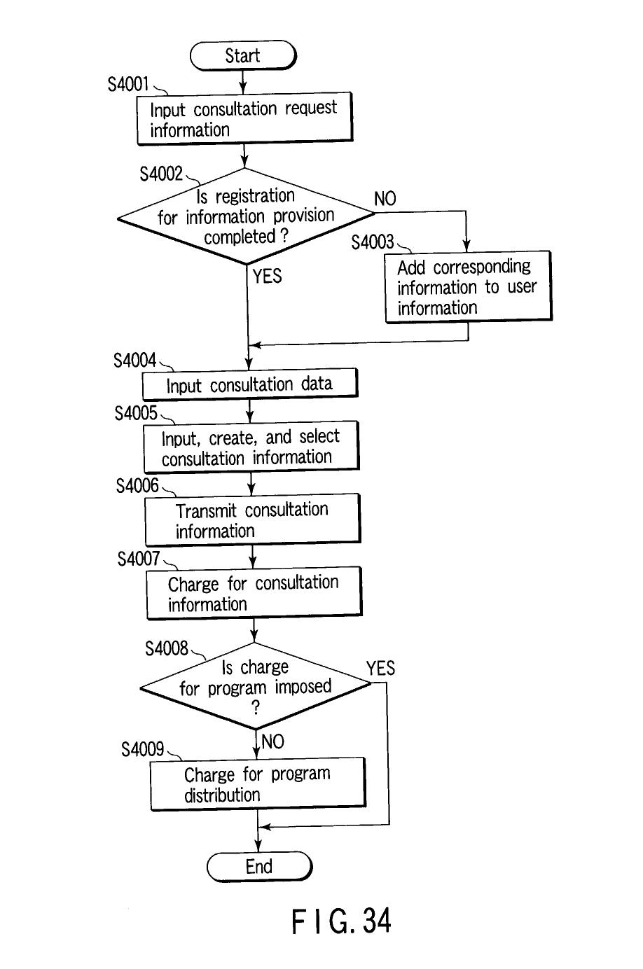

If consultation information distribution is registered as in step S3009 in the above flow chart, consultation information is provided on the basis of the procedure shown in FIG. 34.

First of all, consultation request information is input to the consultation data input section 213 (step S4001). This request may be directly input in the form of a command from an input unit attached to the distributor server or may be input by being transmitted from the user terminal through a communication network. Upon reception of this consultation request information, the distributor server checks whether this user has already been registered as a person who desires the provision of consultation information. If the user has been registered (YES in step S4002), a standby state is set to receive provided data required for consultation. If the user has not been registered (NO in step S4002), information indicating that the user is a person who desires the provision of consultation information is registered in user information (step S4003).

Subsequently, data required to create consultation information, e.g., data obtained by the distributed program, is input to the consultation data input section 213 (step S4004). This data is also input in the form of a command or file by the operator of the distributor server or may be input from the user terminal to the distributor server through a communication network.

When the data for consultation is input in this manner, consultation information is input, created, and selected on the basis of this data and the user information that has already been input at the time of the distribution of the program (step S4005). In this case, consultation information suitable for the user is automatically created or selected by the consultation information creation/selection section 205, or the consultation result obtained by a person who is skilled in data analysis is input from the consultation information input section 214.

The consultation information obtained in this manner is converted into output data by the consultation information output section 210 and distributed from a data output unit (step S4006). When the consultation information is provided in this manner as well, the corresponding charge is accumulated in the charge information creation section 207 and notified to the user (step S4007). In charging the user, it is checked whether a charge for the distribution of the program has already been imposed on the user (step S4008). If no charge is imposed for the distribution of the program, the corresponding charge processing is performed (step S4009).

As described above, according to this embodiment, the program for executing the environmental management system can be widely distributed by a simple procedure. In addition to simple distribution, consultation information can be provided for a user on the basis of the result obtained by executing the distributed program. This makes it possible to construct a more sophisticated management system.

In addition, in distributing such a program or providing consultation information, necessary user information and data for consultation can be properly input in accordance with the advice indicated on an input support display. In addition, this input operation can be advantageously performed by using a network and the like.

Furthermore, since a program to be distributed and consultation information are automatically created or selected on the basis of user information and data for consultation. This makes it possible to provide a program and information suitable for a user. Since charge information for such a program and information is created/stored by the charge information creation section 207, automatization of settlement to be made afterward is facilitated.

According to the above description, charging is performed by the transmission of consultation information. However, the address of a government office (place) to which a report should be made may be registered, so that when no problem arises as a result of consultation, a report is transmitted to the address to which the report should be made, thereby performing charging processing.

[Third Embodiment]

In the third embodiment, the environmental management support system according to the first embodiment is added to a drum management system constituted by a drug measurement unit, drum storehouse, and the like, and drug use data output from the drug management system is input to the environmental management support system, thereby executing environmental management as well as drug management.

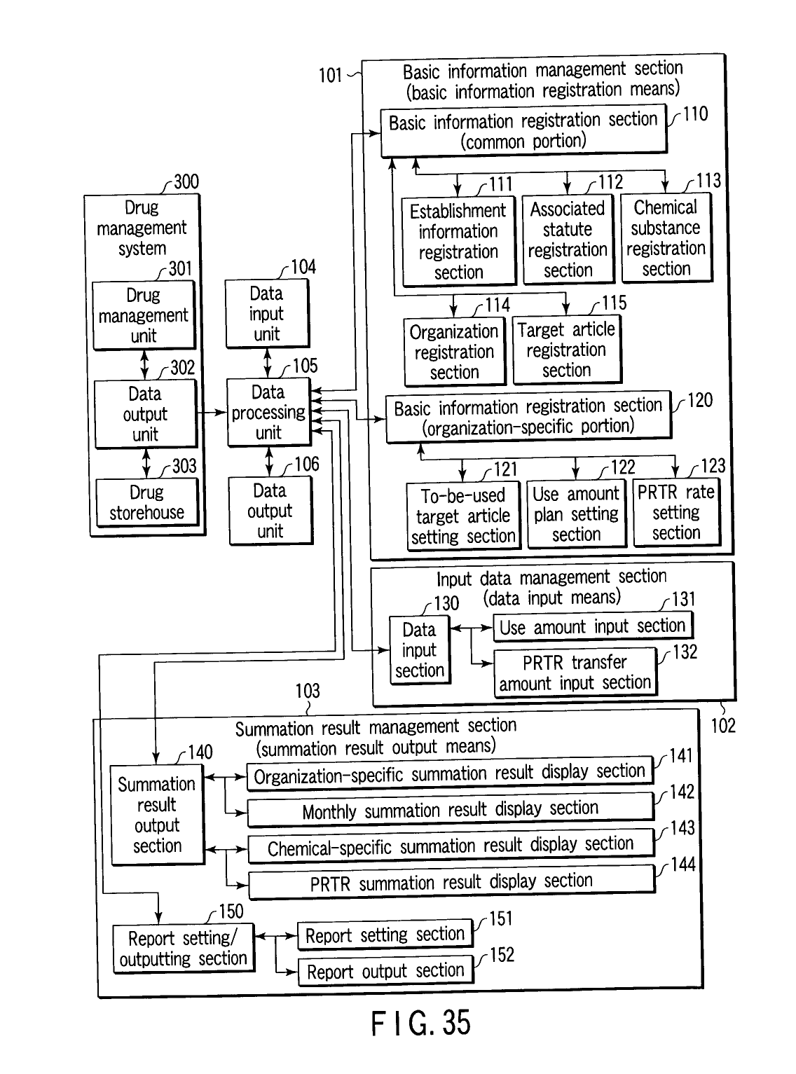

As shown in FIG. 35, the third embodiment is designed such that a drug management system 300 is provided for the arrangement of the first embodiment. The same reference numerals as in FIG. 2 denote the same parts in FIG. 35, and a detailed description will be omitted.

The drug management system 300 is comprised of at least a drug measurement unit 301 such an electronic balance for measuring the weight of a target object and a data output unit 302. The data output unit 302 outputs, for example, data about a drug name, use amount, use date, druggist, and a place where the drum is used. The drug management system also includes a drug storehouse 303 which stores drugs.

A data processing unit 105 of the environmental management support system receives output data from the drug management system 300. This input data may be input through a storage medium such as a memory card or a communication network.

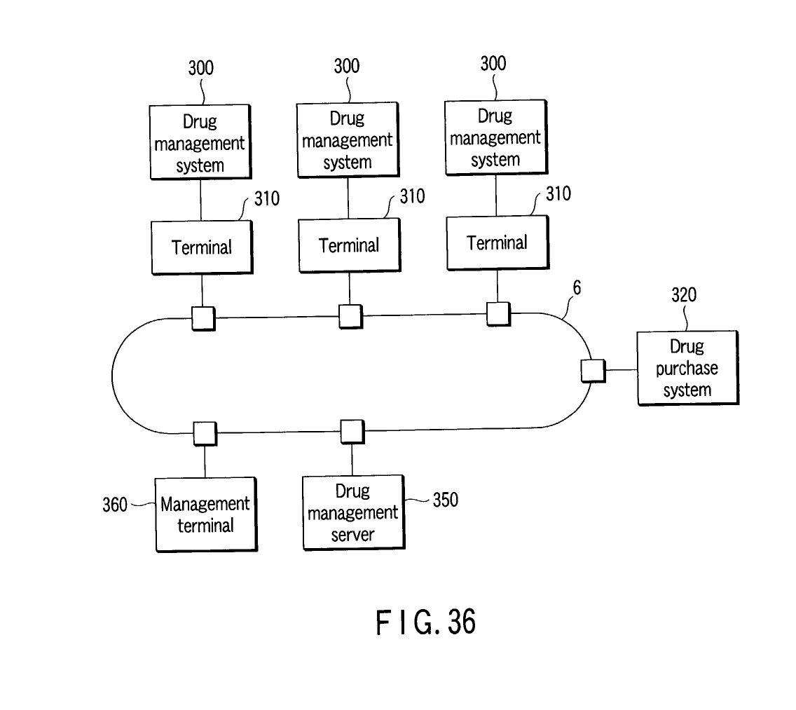

FIG. 36 shows the arrangement of a drug/environmental management support system obtained by connecting the system constituted by the environmental management support system 400 and drug management system 300 to a management terminal 360, drug management server 350, and drug purchase system 405 through a communication network 402.

The operation of the third embodiment having this arrangement will be described with reference to FIG. 35.

As shown in FIG. 35, when a drug is used in the drug management system 300, data such as the drug name, use amount, use date, druggist, place where the drum is used, and the like are output from the data output unit 302 to the drug management system 300. These data are loaded into the data processing unit 105 of the environmental management support system through a storage medium as a memory card or the communication network.

The operation of the embodiment in which the system (to be referred to as “drug management system 300” in this embodiment) constituted by the environmental management support system and drug management system 300 is connected to the drug management server 350 and a drug purchase system 320 through a communication network 6 will be described with reference to FIG. 36.

As shown in FIG. 36, the data of the system constituted by the drug management system 300 installed in a single or a plurality of places can be managed by the management terminal 360 through the communication network 6. In addition, the database of the drug management server 350 can be accessed from each terminal 310 or the management terminal 360.

In addition, this system is designed such that data associated with the acceptance of a drug, e.g., the drug name, acceptance amount, and acceptance date/time, and the like, can be transmitted from the drug purchase system to the terminal 310 of each system or the management terminal 360 through the communication network 6.

Server login performed by each terminal 310 is limited by login name+password management.

As described above, according to this embodiment, drug purchase amount management and use amount management, which are separately performed in the prior art, are systematized to allow drug incoming/outgoing management can be done. This makes it possible to prevent illegal purchase and illegal use. In addition, by loading the use amount of a target article using the drug measurement unit 301, accurate management can be done on the basis of the actual use amounts and transfer rates. No human error due to manual input operation is produced unlike in the prior art.

In addition, each terminal can obtain data associated with the acceptance of a drug from the drug purchase system through a communication network, thus facilitating incoming/outgoing management.

Furthermore, in each terminal, server login is limited by login name+password management to allow security management.

[Fourth Embodiment]

In the fourth embodiment, an MSDS information registration section 116 is provided for target article information registration by the target article registration section 115 of the environmental management support system described in the first embodiment.

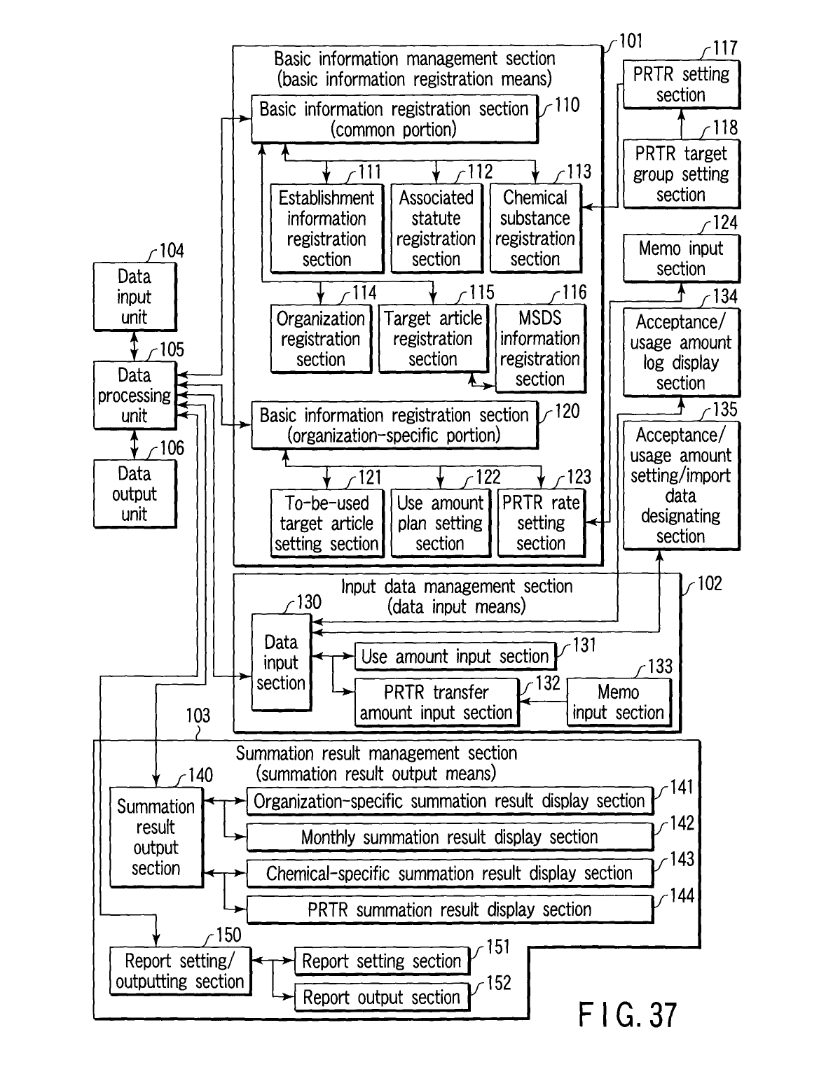

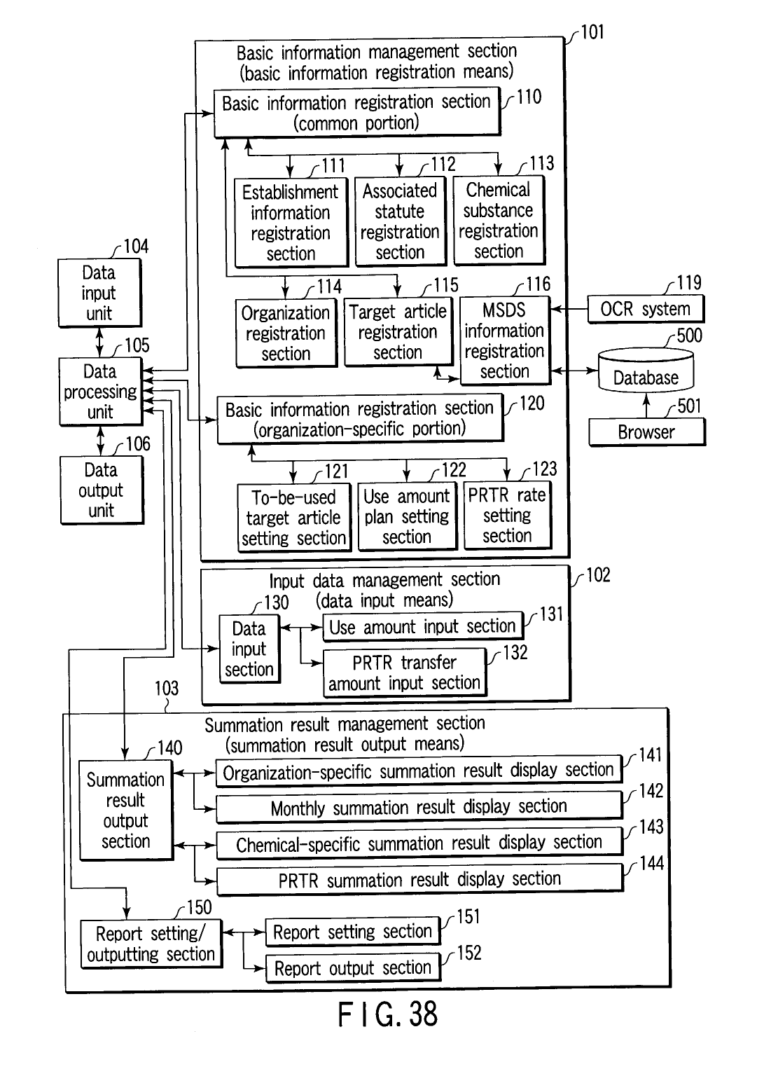

In this embodiment, as shown in, for example, FIG. 37, the MSDS information registration section 116 is provided for the arrangement of the first embodiment. FIG. 38 shows an example of a system configuration having the environmental management support system connected to an OCR system 119 capable of MSDS information into a text.

The operation of the fourth embodiment having this arrangement will be described with reference to FIG. 37.

As shown in FIG. 37, the MSDS information of a target article can be input by using the MSDS information registration section 116. In addition, a PRTR target group setting section 118 classifies chemical substances as PRTR targets into groups, and a PRTR setting section 117 sets PRTR codes for the respective chemical substances on the basis of the groups, thereby registering chemical substances corresponding to PRTR. Note that FIG. 37 shows memo input sections 124 and 133, acceptance/use amount log display section 134, and acceptance/use amount setting/import data designating section 135 which will be described in detail later.

As shown in FIG. 38, MSDS information from the OCR system 119 can be converted into a text, and the data can be pasted for each item in the MSDS information registration section 116.

As described above, according to this embodiment, since a user can input the MSDS information of only target articles without possessing the MSDS information of all chemical substances registered in the system, unlike the prior art, the downsizing of a system database can be attained, and a low-cost system can be provided.

As compared with a case where environmental management and MSDS management are performed by different systems, unification of input operation can be realized by registering MSDS information and the MSDS information can be uniformly managed as common information in the environmental management support system.

By pasting text information obtained by the OCR system 119 for each MSDS item, information management can be efficiently performed as compared with manual input operation.

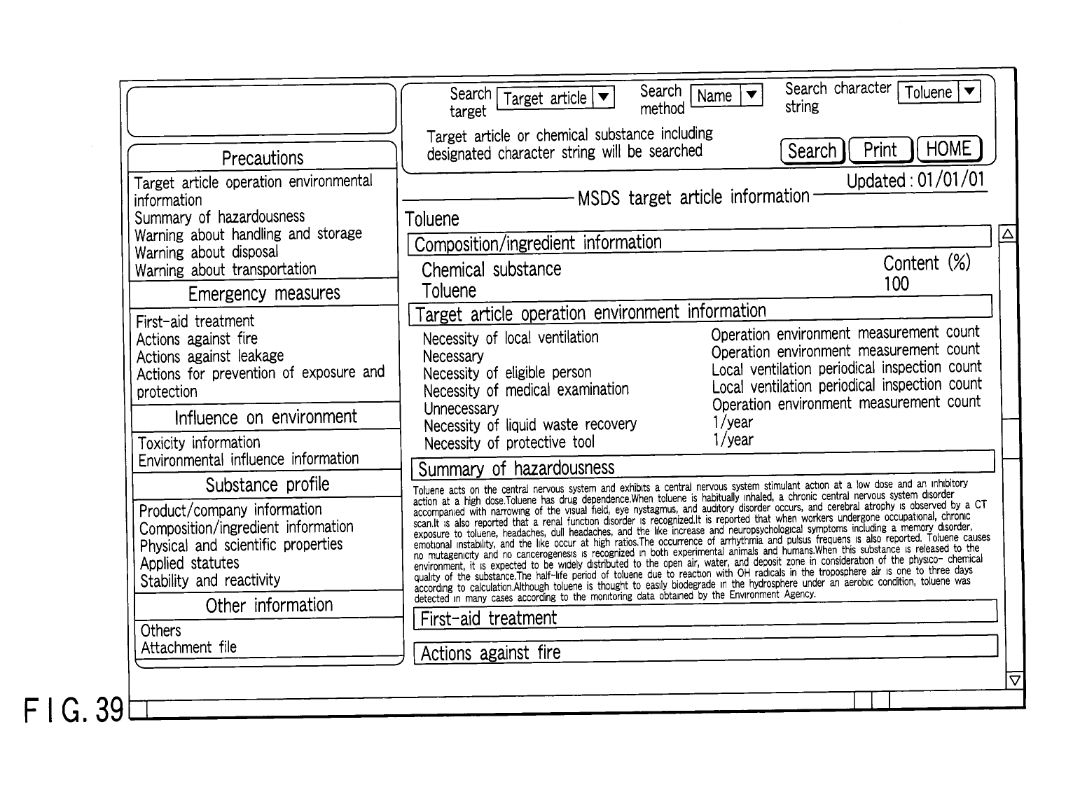

In addition, if the data registered by the MSDS information registration section 116 is registered in a database 500, the MSDS information of the corresponding drugs can be checked by a browser 501 shown in FIG. 39. This makes it possible to improve the awareness of hazardousness about drugs.

The memo input sections 124 and 133 correspond to a function of leaving setting evidences for, e.g., PRTR transfer rates, for the respective processes.

The memo input sections 124 and 133 are sections for inputting a method of measuring the transfer amount input by a PRTR transfer amount input section 132 and a setting ground for the transfer rate input by a PRTR transfer rate setting section 123. The memo input sections 124 and 133 have memo input display sections.

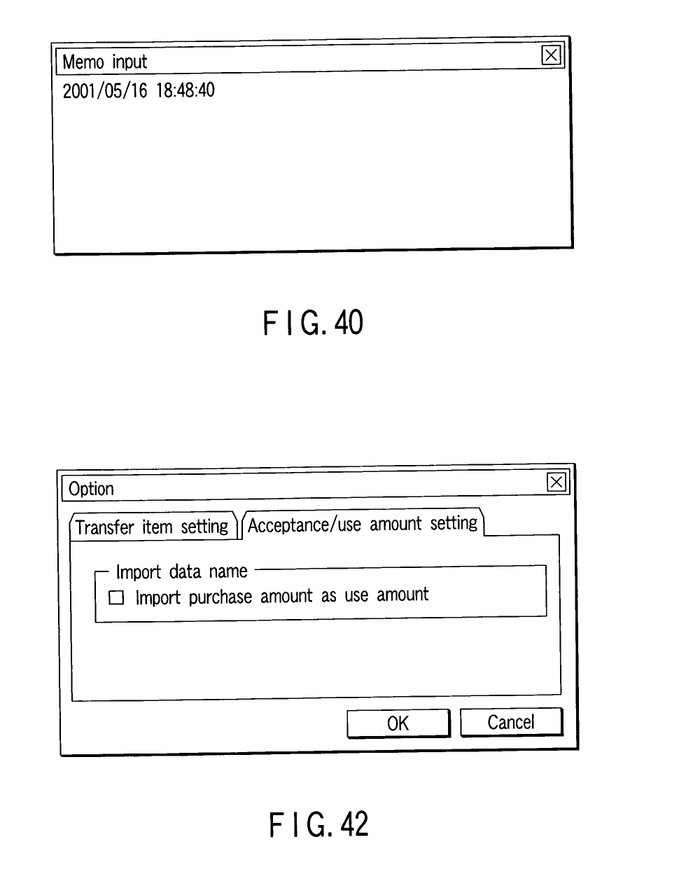

FIG. 40 is a view showing a window display on the memo input section based on the PRTR transfer amount input section 132 and PRTR transfer rate setting section 123.

As shown in FIG. 40, each of the memo input sections 124 and 133 has at least a blank portion which is used to make a user input a memo. The date when a memo is written is automatically inserted in the uppermost line on the blank portion.

As described above, the memo input sections 124 and 133 are provided for the PRTR transfer amount input section 132 and PRTR transfer rate setting section 123, and a date is automatically inserted in the uppermost line of a memo. This makes it possible to leave the setting ground for the memo.

A registration log function for acceptance amounts/use amounts will be described next.

The acceptance/use amount log display section 134 corresponds to a section for leaving a log when acceptance amounts and use amounts are input/changed.

That is, the acceptance/use amount log display section 134 is a section for displaying the log of data input/changed by the acceptance/use amount input section.

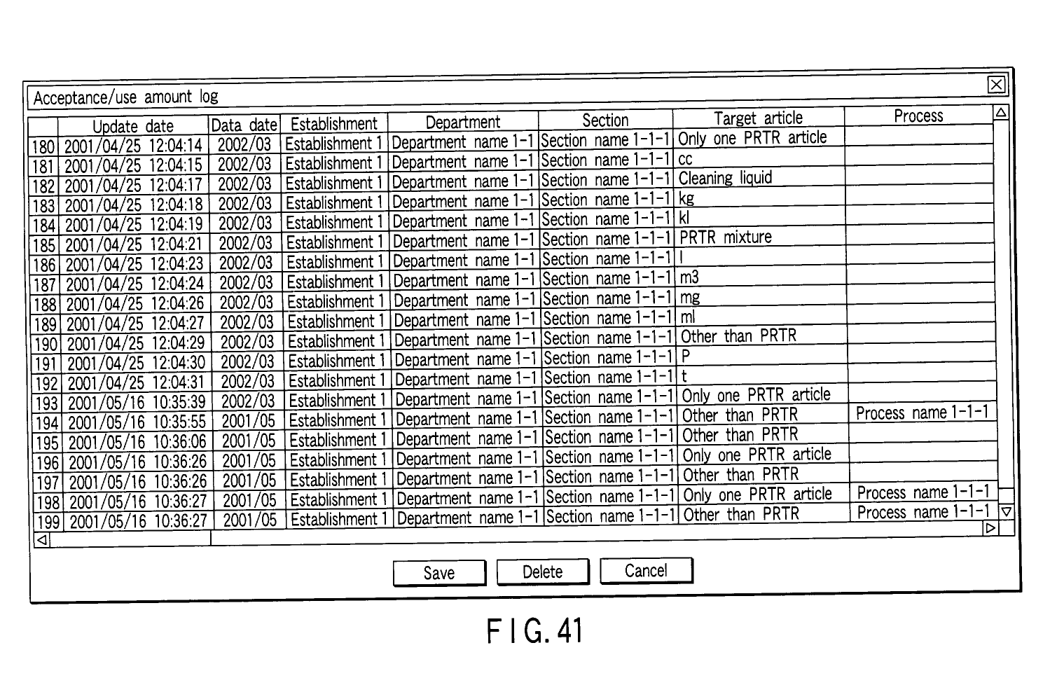

FIG. 41 is a view showing a window display on the acceptance/use amount log display section 134. As shown in FIG. 41, the acceptance/use amount log display section 134 displays the date when data was input/changed by the acceptance/use amount input section, the date of the data, establishment, department, section, target article, process, item, and contents.

The acceptance/use amount log display section 134 manages inputs monthly, and can display the log of data input/changed by the acceptance/use amount input section. This makes it possible to leave a more detailed log.

The acceptance/usage amount setting/import data designating section 135 corresponds to a section for importing purchase amount import data from other systems such as a purchase acceptance system.

More specifically, the acceptance/usage amount setting/import data designating section 135 is a section having a function of choosing, in importing purchase import data, inputting all amounts as use amounts or inputting some amounts as use amounts.

FIG. 42 is a view showing a window display on the acceptance/usage amount setting/import data designating section 135. As shown in FIG. 42, the acceptance/usage amount setting/import data designating section 135 can choose whether to import import data, i.e., whether a purchase amount is imported as a use amount.

As described above, in importing acceptance amount import data in cooperation with other systems such as a purchase system, since the acceptance/usage amount setting/import data designating section 135 has the function of selecting some of all imported acceptance amounts as use amounts, even a case where an acceptance amount does not coincide with a use amount can be properly handled.

The PRTR transfer rate setting section 123 shown in FIG. 37 is a section for the transfer rates of chemical substances as PRTR targets or compounds including PRTR targets on a process basis in each organization.

More specifically, the PRTR transfer rate setting section 123 displays, as initial values in the PRTR transfer rate input section, 100% in “others” and 0% in each of the remaining items (e.g., atmosphere, public water area, soil, self-supporting reclamation, disposal by establishment, sewerage, drainage, product conversion, by-product, decomposition, and treatment facilities).

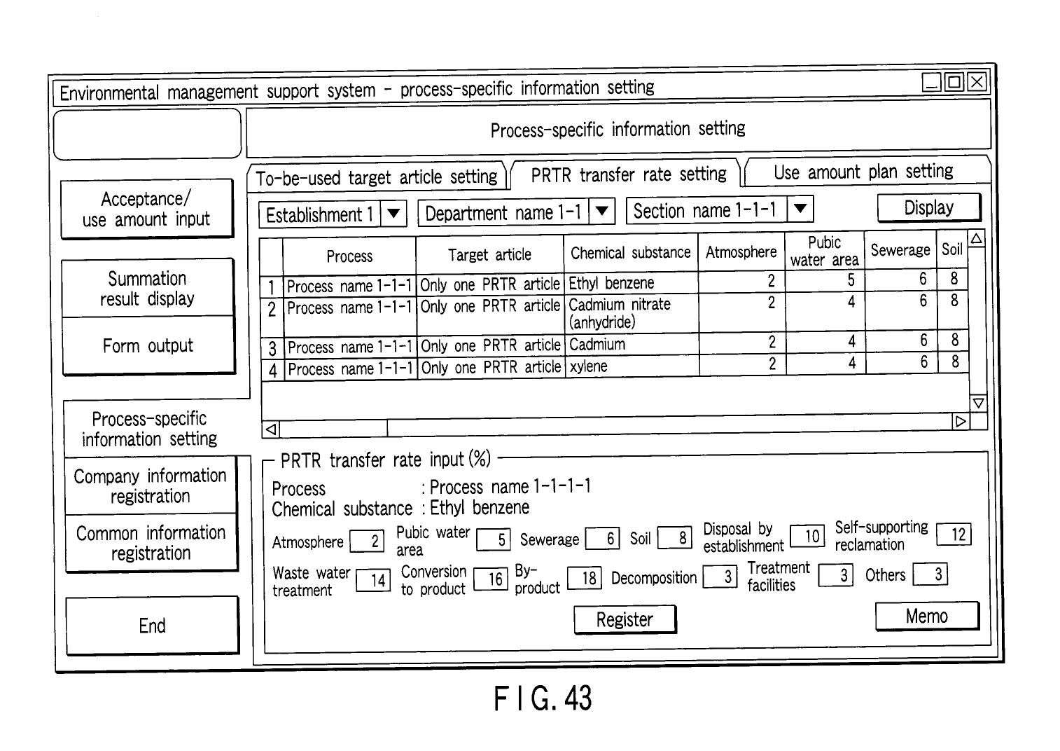

FIG. 43 is a view showing a window display on the PRTR transfer rate setting section 123.

As shown in FIG. 43, when a PRTR transfer rate is input in each item by using the PRTR transfer rate setting section 123, the value obtained by subtraction of the input value is displayed in the “others” item.

By displaying 100% in the “others” item and 0% in each of the remaining items as initial values in the PRTR transfer rate input section, the input operation time at the site can be shortened.

In addition, by providing the function of adding/subtracting with respect to the “others” item, the necessity to calculate a total % is eliminated, and the operation time can be shortened.

The PRTR target group setting section 118 of the common information/PRTR setting section 117 is a section for adding/deleting PRTR target groups of chemical substances and changing conversion coefficients.

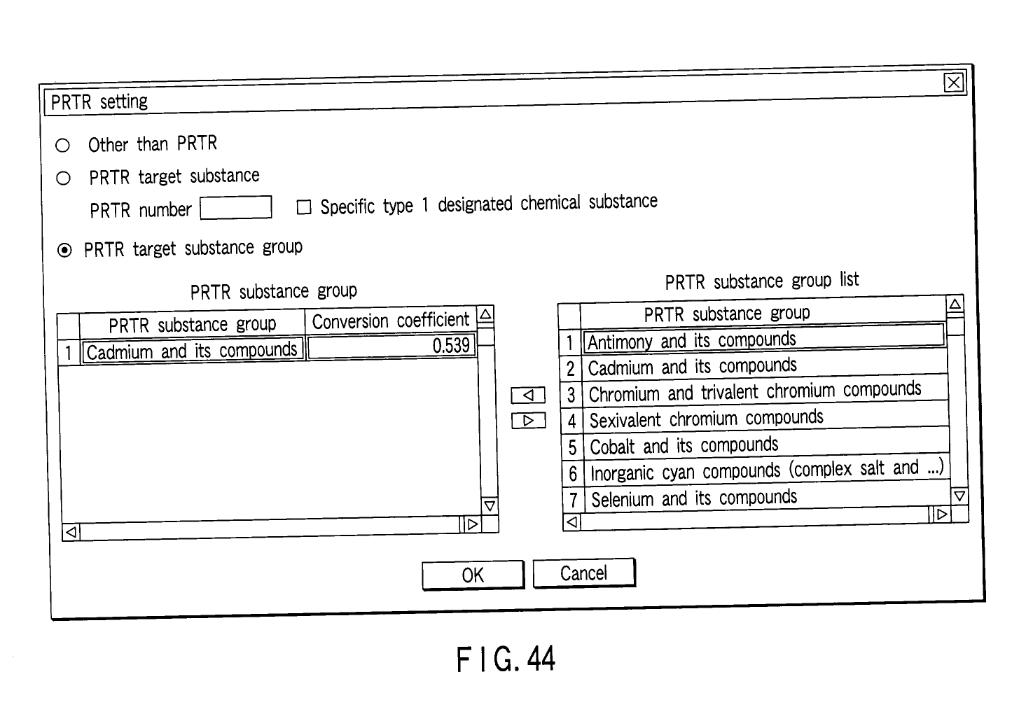

FIG. 44 is a view showing a window display on the PRTR target group setting section 118.

As shown in FIG. 44, the PRTR setting section 117 can add/delete a PRTR target group of chemical substances, and can also change the corresponding conversion coefficient to an arbitrary value.

Since the PRTR setting section 117 can add/delete a PRTR target group of chemical substances, and can also change the corresponding conversion coefficient to an arbitrary value, even chemical substances that are not registered in the database can be properly handled.

[Fifth Embodiment]

The fifth embodiment is associated with correction of the PRTR transfer amount calculated by a data input section. If a transfer amount to the release destination designated by this system can also be actually measured, an actual release amount obtained by actual measurement is calculated, and the calculation result obtained from a transfer rate used as a default value is corrected/input (in this embodiment, this correction/inputting based on actual measurement will be referred to as “measurement value management function”). Release destination for which actual measurement can be done include a public water area, sewerage, atmosphere, waste, and the like.

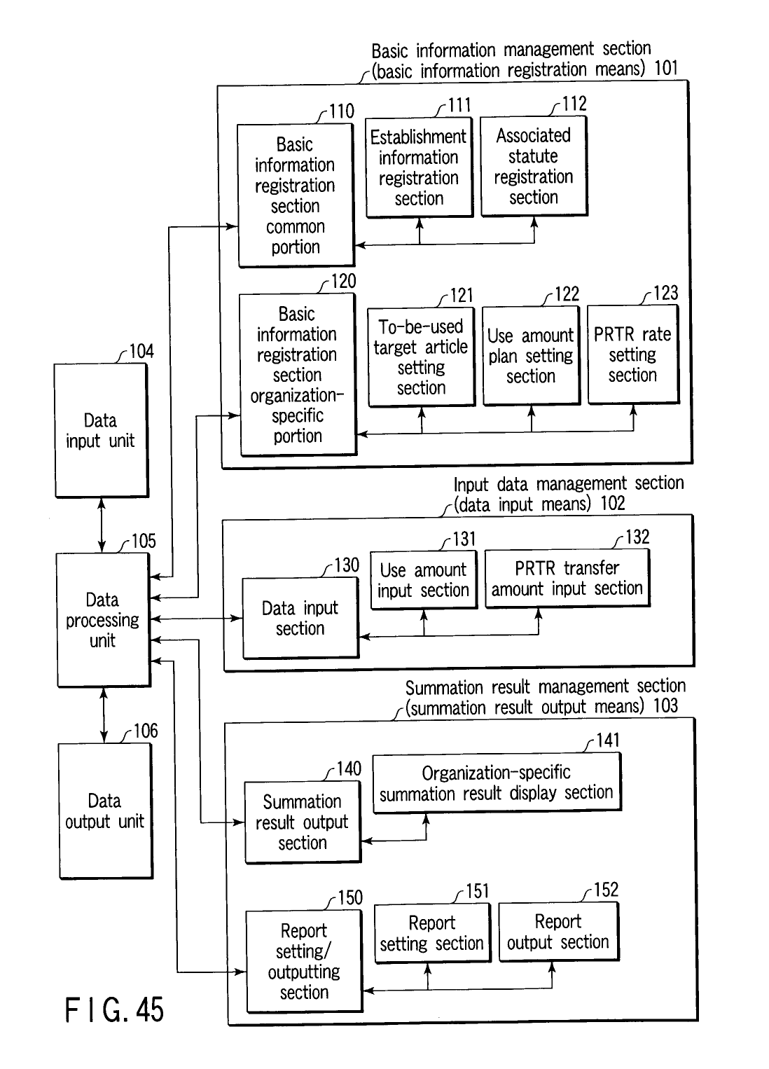

FIG. 45 is a functional block diagram showing the overall arrangement of the measurement value management function. As shown in FIG. 45, according to this function, a program constituted by three management sections, namely a basic information management section (basic information registration means) 101, input data management section (data input means) 102, and summation management section (summation result output means) 103 is executed by hardware constituted by a data input unit 104, data processing unit 105, and data output unit 106. In addition, since the measurement value management function has almost the same arrangement as that of this system, this function may be incorporated as part of the function of the system to execute the function within the same system.

The basic information management section 101 has a basic information registration section 110 for a common portion and a basic information registration section 120 for an organization portion. The input data management section 102 has a data input/output section 130. The summation management section 103 has a summation result display section 140 and report setting/outputting section 150.

More specifically, the basic information registration section 110 for the common portion corresponds to the work done by environmental management staff having an expert knowledge about environmental management and, more specifically, an expert knowledge about management of analysis values and measurement values. The basic information registration section 110 has at least an associated statute registration section 111 associated with ventilation, drainage, wastes, and the like which demand analysis and an analysis item registration section 112 for registering information associated with target analysis items.

The basic information registration section 120 for the organization portion has an establishment information registration section 121 for registering information associated with facilities, establishment, and the like which possess survey places, a survey place registration section 122 for registering information associated with survey places existing in organizations, and an analysis item setting/registering section 123 for setting analysis items for each survey places in each organization.

The data input/output section 130 corresponds to the work done by an environmental data manager for storing the values actually measured in survey places. More specifically, the data input/output section 130 has a survey data input section 131 for registering the values measured in survey places and a release amount totalizing section 132 for calculating the release amount of analysis item from the measurement value, ventilation, drainage, and the release amount of waste in a survey place and the measurement value of the analysis item.

The release amounts of analysis items corresponding each survey place which are totalized by the release amount totalizing section 132 can be displayed, together with the default values calculated on the basis of transfer rates, in the process of bringing the calculation result to the corresponding survey place in this system, thereby allowing them to be compared with each other. The default value can be corrected to the measurement value on the basis of user decision.

The summation result display section 140 corresponds to the management work done by a facility or establishment manager. More specifically, the summation result display section 140 calculates the concentration of an analysis item or, for example, its maximum, minimum, or average value, on the basis of the measurement value of the analysis item which is input by the data input/output section 130. This summation result display section has a place-specific summation display section 141 for displaying analysis values for the respective survey places with the survey places being used as keys. For example, a period-specific summation display, analysis-item-specific summation display, and the like may be added as constituent elements depending on what are to be totalized into each key.

The report setting/outputting section 150 corresponds to report creation work for reports directed to government and municipal offices and voluntary management. The report setting/outputting section 150 has a report setting section 151 for making output settings for reports in accordance with statutes and the like, and a report output section 152 for outputting reports in set forms.

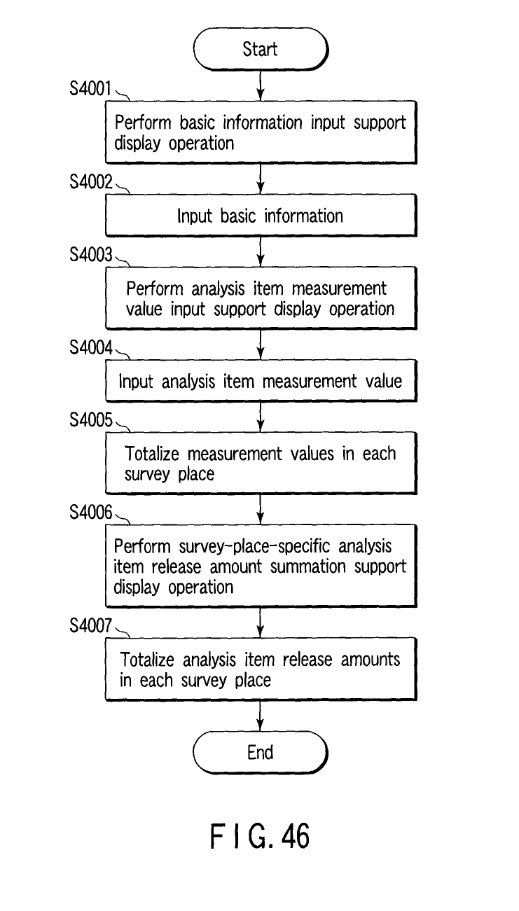

FIG. 46 is a flow chart showing an outline of the operation of the measurement value management function. As shown in FIG. 46, input support display operation is performed for basic information including a department name, the identification names of one or more survey places in the department, and analysis items, and analysis items for the respective survey places (step S4001). The basic information input from the user and analysis items for the respective survey places are registered (step S4002).

Subsequently, input support display operation is performed for the measurement value data of analysis items for the respective survey places (step S4003), and the measurement values of the analysis items input from the user are registered (step S4004).

In totalizing input analysis values, the concentrations or measurement values of the analysis items for the respective survey places are directly calculated/displayed, or their maximum, minimum, or average values or the like are calculated/displayed (step S4005).

In addition, input support display operation is performed to designate a period for each survey place and calculate the release amount of each analysis time released in the period (step S4006). The release amount of each analysis item is calculated from the release amount in the survey place and the concentration of the analysis item which are input from the user, and the calculated release amount is displayed (step S4007).

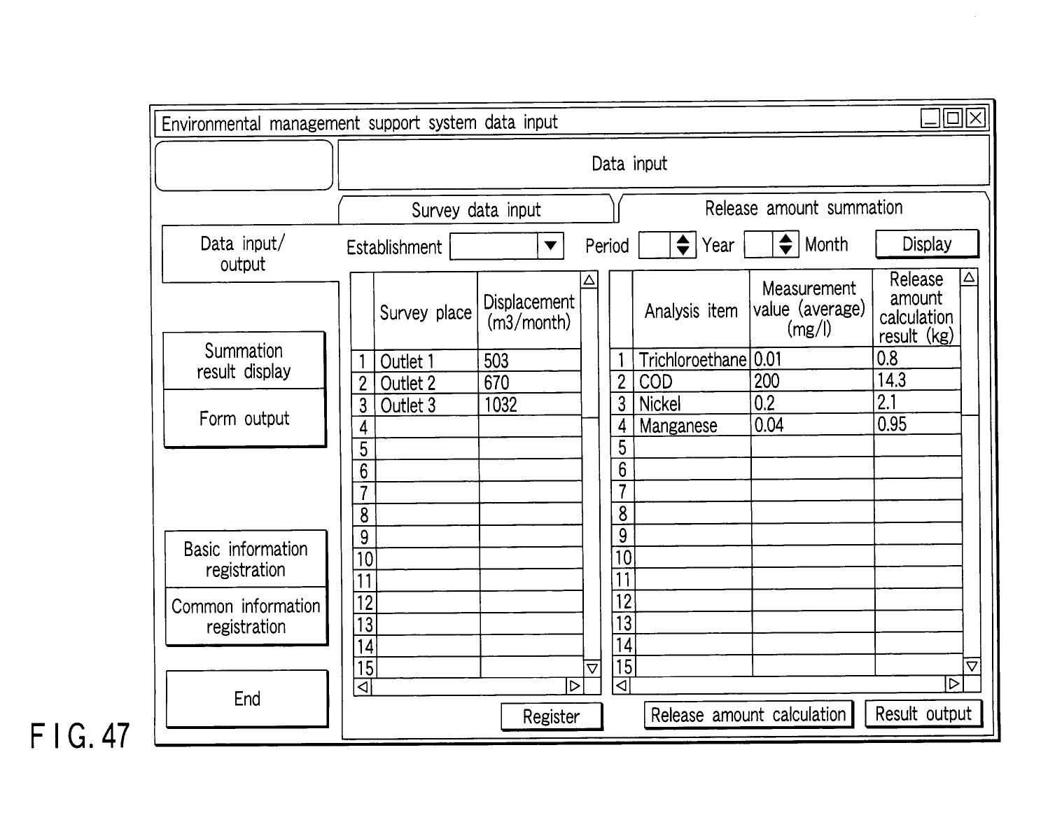

FIG. 47 is a view showing a window display for release amount summation result display by the release amount totalizing section 132 of the data input/output section 130. As shown in FIG. 47, the release amount totalizing section 132 displays a selection window for the organizations registered by the basic information registration section 110 and a selection window for survey dates to define survey periods, which are registered by the survey data input section of data input/output section 130. In accordance with the organization and period designated by the user on the selection windows, the release amount totalizing section 132 displays a survey place belonging to the selected and analysis items belonging to the survey place.

The total release amount in the period and the concentrations of the analysis items in the displayed survey place are totalized/displayed on the basis of registered data or input by the user, thereby the calculated release amounts of the analysis items are output to the calculation result display column.

[Other Embodiments]

Note that the present invention is not limited to the above embodiments and variously modified within the spirit and scope of the invention. For example, the arrangements of the respective functional sections, e.g., the basic information management section, input data management section, and summation result management section, can be arbitrarily changed. For example, in the first embodiment described above, the summation result output section and report setting/outputting section may be formed into a single functional section. In addition, the procedures to be executed are not limited to those shown in the respective flow charts and may include various procedures in accordance with actual needs.

What is claimed is:

1. An environmental management support system which calculates a release or transfer amount of a chemical substance contained in a target article, characterized by comprising:
basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes;
data input means having a use amount input section which inputs use amount data about a target article in each of the processes and calculates a release or transfer amount of the chemical substance contained in the target article in a predetermined period for each of the processes by using the input data and each information stored by said basic information registration means; and
means for outputting the release or transfer amount of the chemical substance calculated by said data input means for each of the processes.

2. An environmental management support system which calculates a release or transfer amount of a chemical substance contained in a target article, characterized by comprising:
basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes;
data input means having a use amount input section which input use amount data about a target article in each of the processes and calculates a release or transfer amount of the chemical substance contained in the target article in a predetermined period for each of the processes by using the input data and each information stored by said basic information registration means, and a transfer amount input section which allows the calculated release or transfer amount to be corrected/input, corrects, when correcting/inputting operation is performed, the corresponding release or transfer rate information, and allows the corrected release or transfer rate information to be identified, or a correction log is allowed to be displayed when the release or transfer rate information is to be displayed; and
means for outputting the release or transfer amount of the chemical substance calculated or corrected by said data input means for each of the processes.

3. A server in an environmental management support system which calculates a release or transfer amount of a chemical substance contained in a target article by using a computer system in which a terminal and said server are connected to each other through a communication network, characterized by comprising:
basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes;
data input means having a use amount input section which input use amount data about a target article in each of the processes from said terminal and calculates a release or transfer amount of the chemical substance contained in the target article in a predetermined period for each of the processes by using the input data and each information stored by said basic information registration means, and a transfer amount input section which allows the calculated release or transfer amount to be corrected/input, corrects, when correcting/inputting operation is performed, the corresponding release or transfer rate information, and allows the corrected release or transfer rate information to be identified, or a correction log is allowed to be displayed when the release or transfer rate information is to be displayed; and
means for outputting the release or transfer amount of the chemical substance calculated or corrected by said data input means for each of the processes,
wherein said respective means can be activated independently of each other.

4. A server in an environmental management support system according to claim 3, characterized in that
said terminal includes a mobile terminal apparatus, and
at least said data input means of said respective means is configured to input data by using said mobile terminal apparatus.

5. A computer-readable storage medium storing a program for calculating a release or transfer amount of a chemical substance contained in a target article,
characterized in that the program can execute
basic information registration means having a target article registration section which stores information associated with a target article, including information for specifying the target article, information for specifying a predetermined chemical substance contained in the target article, and content information of the chemical substance, and a transfer rate setting section which stores identification information of at least one process including a plurality of tasks and can set release or transfer rate information of the chemical substance for each of the processes;
data input means having a use amount input section which input use amount data about a target article in each of the processes and calculates a release or transfer amount of the chemical substance contained in the target article in a predetermined period for each of the processes by using the input data and each information stored by the basic information registration means, and a transfer amount input section which allows the calculated release or transfer amount to be corrected/input, corrects, when correcting/inputting operation is performed, the corresponding release or transfer rate information, and allows the corrected release or transfer rate information to be identified, or a correction log is allowed to be displayed when the release or transfer rate information is to be displayed; and
means for outputting the release or transfer amount of the chemical substance calculated or corrected by the data input means for each of the processes.

6. An environmental management support method of calculating a release or transfer amount of a regulated substance, of chemical substances contained in a target article of a user, which is designated as a management or report target by a statute, by using a computer system in which a terminal on a user side and a server on an environmental management support company side are connected to each other through a communication network, and providing a calculation result for a user, characterized by comprising steps of:
storing statute-associated information including information for specifying a regulated substance in a storage device of the server;
storing, in the storage device of the server, target-article-associated information including information for specifying a target article containing a chemical substance, information for specifying the chemical substance, and a content of the chemical substance;
determining, by using the statute-associated information and the target-article-associated information stored in the respective steps, whether the chemical substance is a regulated substance, and storing information for specifying the target article, information for specifying a regulated substance contained in the target article, and a content of the regulated substance as regulated-substance-associated information in correspondence with each other in the storage device of the server;
storing identification information of at least one process including a plurality of tasks and release or transfer rate information of a regulated substance in each of the processes in the storage device of the server;
outputting, to the terminal on the user side, display to prompt the user to input use amount data of a target article in each of the processes;
receiving use amount data input to the terminal on the user side through a communication network;
calculating a release or transfer amount of a regulated substance contained in a target article in each of the processes in a predetermined period on the basis of the received use amount data and the respective pieces of information stored in the storage device of the server;
transmitting the calculated release or transfer amount information to the terminal on the user side;
outputting, to the terminal on the user side, display to prompt the user to correct/input the transmitted release or transfer amount information;
receiving the release or transfer amount information corrected and input to the terminal on the user side through a communication network;
correcting the corresponding release or transfer rate stored in the storage device on the basis of the received release or transfer amount; and
in transmitting release or transfer rate information to the terminal on the user side, allowing the corrected release or transfer rate information to be identified or transmitting the corrected release or transfer rate information, together with a correction log display, to the terminal on the user side.

7. An environmental management support method of calculating a release or transfer amount of a chemical substance contained in a target article of a user by using a computer system in which a terminal on a user side and a server on an environmental management support company side are connected to each other through a communication network, and providing a calculation result for a user, characterized by comprising steps of:
outputting, to the terminal on the user side, display to prompt the user to input basic information including information for specifying the target article, information for specifying a predetermined chemical substance contained in the target article, content information of the chemical substance, identification information of at least one process including a plurality of tasks, and release or transfer rate information of the chemical substance for each of the processes;
receiving the basic information input to the terminal on the user side through a communication network and storing the information in a storage device of the server;
outputting, to the terminal on the user side, a display to prompt the user to input use amount data of a target article in each of the processes;
receiving use amount data input to the terminal on the user side through the communication network;
calculating a release or transfer amount of the chemical substance contained in the target article in each of the processes in a predetermined period on the basis of the received use amount data and the respective pieces of information stored in the storage device of the server;
outputting, to the terminal on the user side, a display to prompt the user to correct/input the transmitted release or transfer amount information;
receiving the release or transfer amount information corrected and input to the terminal on the user side through the communication network;
correcting the corresponding release or transfer rate stored in the storage device on the basis of the received release or transfer amount; and
in transmitting release or transfer rate information to the terminal on the user side, allowing the corrected release or transfer rate information to be identified or transmitting the corrected release or transfer rate information, together with a correction log display, to the terminal on the user side.

8. An environmental management support method according to claim 6 or 7, characterized by further comprising a step of transmitting consultation information based on the release or transfer amount data in each of the processes to the terminal on the user side.
